(19) United States
(12) Patent Application Publication
(10) Pub. No.: US 2022/0171905 A1
(43) Pub. Date: Jun. 2, 2022

(54) MULTI-TIME STEPPING INTEGRATION METHOD WITH DIRICHLET-ROBIN INTERFACE COUPLING AND APPLICATIONS OF SAME

(71) Applicant: NORTHWESTERN UNIVERSITY, Evanston, IL (US)

(72) Inventors: Gregory J. Wagner, Evanston, IL (US); Lin Cheng, Evanston, IL (US); Mohammadjavad Sarfi, Evanston, IL (US)

(21) Appl. No.: 17/536,244

(22) Filed: Nov. 29, 2021

Related U.S. Application Data
(60) Provisional application No. 63/120,262, filed on Dec. 2, 2020.

(51) Int. Cl. G06F 30/23

(52) U.S. Cl. CPC G06F 30/23; G06F 2119/12

(57) ABSTRACT

This invention relates to a novel method for accelerating time integration of the heat equation based on a decomposition of the solution domain into multiple regions, allowing a different discrete time step size in each domain. Domains are coupled at interfaces using a novel formulation for the boundary condition, including a mixed (Robin) condition for the small timestep domain that uses a coupling parameter optimized for stability and accuracy. This algorithm allows many-times speedup for simulation of systems such as additive manufacturing of metals, where fast evolution of the solution field is limited to a small region while the remainder of the domain evolves more slowly.

### CROSS-REFERENCE TO RELATED PATENT APPLICATION

This application claims priority to and the benefit of U.S. Provisional Application Ser. No. 63/120,262, filed Dec. 2, 2020, which is incorporated herein in its entirety by reference.

### FIELD OF THE INVENTION

The present invention relates generally to material science, and more particularly to a multi-time stepping integration method with Dirichlet-Robin interface coupling, and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Transient heat conduction problem has drawn great interests recently due to its broad influences on the product quality of additive manufacturing, such as select laser melting (SLM), select laser sintering of polymers (SLS), etc. These processes can be treated as a transient heat conduction procedure, in which the deposition material is melted and solidified in a layer by layer fashion. This makes it possible to fabricate the complex geometries without considering the increase of the cost due the increase of the geometric complexity. Nevertheless, the transient heat conduction also leads to severe problems such as residual stress accumulation, overheating and undesirable build failure. Simulation for transient heat conduction is thus the natural choice for understanding the underlying mechanism and for addressing those undesirable problems. However, due to its involved difference in space and time, rapid change in nonlinear material behavior, dynamical growth of the domain, and the required accuracy in specific small area (i.e., melting pool region), the computational cost for such a process is high.

In the practical fabrication, the rapid change of the temperature is only centered at a small region (i.e., melting pool region) comparing to the whole domain. This implies that a large part of the domain remains to be relatively stationary while the dramatic change is only a local behavior. Considering the desired accuracy in those regions, it would be efficient to split the domain into a number of subdomains and employ multi-time stepping integrators in different subregions. This is the spirit of the domain decomposition methods, in which a large and computational cumbersome problem is divided into several smaller problems and is solved simultaneously.

Domain decomposition methods (DDM) have been extensively studied in the past several decades since the seminal work of Schwarz algorithm. As regards multi-time stepping DDM for transient problem, Belytschko et al. proposed a nodal partition-based mixed methods for time integration and an implicit-explicit time integrators is used to solve second-order equations. Hughes and Liu developed an element partition-based method for the DDM. The difference between these two methods is that node partitioning methods group different sets of nodes to different subdomains and the interfaces are created by the shared elements; while the element partition methods is quite the opposite. For the multi-time stepping methods, there is a system timestep defined over the whole domain, while the time integrators of different subdomains are equal to or smaller than the system timestep. This makes it possible to replace the solution of a large problem by solving a bunch of the smaller problems in a parallel fashion, in order to accelerate the simulation process. Smolinski et al. have used both node and element partition method to study both the steady and unsteady diffusion problem with explicit time integrators and have analyzed their stability. Since explicit time integrators is conditionally stable, Daniel expanded these methods to implicit/implicit partition by extending the generalized trapezoidal rule to multiple timesteps and provided rigorous proofs for the stability and accuracy numerically.

Along with the categorization by node partition and element partition, DDM can also be classified into overlapping and non-overlapping methods. Overlapping methods are also named Schwarz methods, which assumes that the subdomains have overlapping regions in the decomposition. While the non-overlapping methods have no overlapping regions among the subdomains and are also known as Schur complement methods or sub-structuring methods. In this work, we will mainly focus on the non-overlapping methods. One of the most popular non-overlapping methods is the well-known Finite Element Tearing and Interconnecting methods (FETI). In FETI methods, the continuity across the interfaces along different subdomains are enforced through a dual variable calculated by Schur complement operator. The dual variable is then added to the subdomains as a Lagrange multiplier for solving the interior degrees of freedom. The FETI method is originally developed for static problems and later extended to transient problems by Farhat et al. Based on FETI framework, Combescure and Gravouil proposed the multi-time stepping methods for time-dependent nonlinear problems while Prakash et al. further improved those methods.

In particular for transient heat conduction, Nakshatrala et al. proposed a FETI-based multi-time stepping method by using a dual Schur formulation. The continuity along the interfaces of the subdomains is maintained by explicitly computing the Lagrange multipliers and attributing them as interface fluxes. Nakshatrala et al. proposed a time-staggered mixed-multi-timestep coupling algorithm based on Nitsche's method to avoid the potential stability problems associated with Lagrange multipliers. In these works, the continuity along the interfaces of the subdomains is enforced by maintaining the continuity of the rate of primary variables through penalty terms. In other words, both Dirichlet and Neumann boundary conditions are needed for variable continuity and energy conservation, respectively. However, as proved by Roux et al., the stability of these Dirichlet-Neumann iteration method strongly depends on the relative properties of media between the subdomains along the interface. Although a suitable relaxation parameter can be added to address this problem, the magnitude of the relaxation parameter is problem dependent and is difficult to select when the materials are heterogeneous on both sides of the interface. This happens to the simulation of AM, in which material properties in the melting pool region change remarkably due to the temperature gradient. This leads to severe instability when using the Dirichlet-Neumann iteration methods. In addition, the artificial relaxation parameter normally needs to be very small, which results in a very slow convergence and conflicts with primary purpose of simulation acceleration.

On the other hand, Roux et al. have proved that Dirichlet-Robin iteration is able to achieve unconditional stability when the additional augmented Robin matrix is equal to the Schur complement matrix. This mitigates the problem of Dirichlet-Neumann iteration method for the dependence of relative properties on both sides of the interface. However, it is difficult to compute the Schur complement matrix for large problem and an artificial large number is manually set to the augmented Robin term.

Therefore, a heretofore unaddressed need exists in the art to address the aforementioned deficiencies and inadequacies.

### SUMMARY OF THE INVENTION

One of the objectives of this invention is to provide an efficient multi-time stepping methodology for transient heat conduction problem in order to accelerate the simulation with desirable accuracy at the small region of interest. In one embodiment, we extend the work of Roux et al. to a time-dependent problem, such as transient heat transfer. Specifically, to achieve stable coupling and accelerate the convergence of Dirichlet-Robin iteration methods, a systematic method is disclosed to obtain the augmented Robin term based on the derivation from 1D problem.

The novel method/algorithm for accelerating time integration of the heat equation is based on a decomposition of the solution domain into multiple regions (a set of subdomains), allowing a different discrete time step size in each domain. Domains are coupled at interfaces using a novel formulation for the boundary condition, including a mixed (Robin) condition for the small timestep domain that uses a coupling parameter optimized for stability and accuracy. This method/algorithm allows many-times speedup for simulation of systems such as additive manufacturing of metals, where fast evolution of the solution field is limited to a small region while the remainder of the domain evolves more slowly.

In one aspect of the invention, the method for accelerating simulation of transient heat conduction comprises:

dividing a domain Ω of transient heat transfer bounded by a boundary of Γ into a set of subdomains {Ωᵢ}, wherein a share boundary of two neighbor subdomains Ωᵢ and Ωⱼ defines an interface Γᵢⱼ^{In} between the two neighbor subdomains Ωᵢ and Ωⱼ;

obtaining a Dirichlet-Robin (DR) coupling on the interface Γᵢⱼ^{In} as

$${k}_{i} \frac{\partial {u}_{i}}{\partial {n}_{i}} + {α}_{ij} {u}_{i} = - {k}_{j} \frac{\partial {u}_{j}}{\partial {n}_{j}} + {α}_{ij} {u}_{j} , on {Γ}_{i j}^{In} \qquad ( C1 )$$

wherein αᵢⱼ is a coefficient to guarantee continuity of the Robin boundary, uᵢ is a temperature field at the subdomains Ωᵢ, nᵢ is a unit normal vector at the Neumann boundary of the subdomains Ωᵢ, and kᵢ is thermal conductivity of a material at the subdomains Ωᵢ;

obtaining a governing equation of the transient heat conduction in the domain Ω by using the DR coupling as

$${\sum }_{i} {\int }_{{Ω}_{t}} {v}_{i} ρ {c}_{p} {\dot{u}}_{i} d Ω + {\sum }_{i} {\int }_{Ω} ∇ {v}_{i} \cdot {k}_{i} ∇ {u}_{i} d Ω + {\sum }_{i} {\sum }_{j} {\int }_{{Γ}_{t j}^{In}} {v}_{i} ( {u}_{i} - {u}_{j} ) {α}_{i j} d Γ + {\sum }_{i} {\sum }_{j} {\int }_{{Γ}_{t j}^{In}} {v}_{i} ( {k}_{i} \frac{\partial {u}_{i}}{\partial {n}_{t}} + {k}_{j} \frac{\partial {u}_{j}}{\partial {n}_{j}} ) d Γ = {\sum }_{i} {\int }_{{Ω}_{i}} {v}_{i} {Q}_{i} d Ω - {\int }_{{Γ}_{N}} v {q}_{{Γ}_{N}} d Γ \qquad ( C2 )$$

where a superposed dot denotes a time derivative, ∇ is a gradient operator, ρ is a density of the material, cₚ represents a specific heat, and q_{Γ}_{_{N}} denotes a heat flux subjected to the Neumann boundary;

focusing on a particular i-j pair, and without loss of generality denote the two bordering regions as 1 and 2; after discretizing using finite elements in space, partitioning arrays of unknowns at nodes, discretizing in time, and using subscript 3 to denote nodes on the interface itself, resulting in governing equation Eq. (C2) for the subdomains in a form of

$$[ \begin{matrix}{\hat{K}}_{11} & 0 & {\hat{K}}_{13} \\ 0 & {\hat{K}}_{22} & {\hat{K}}_{23} \\ {\hat{K}}_{31} & {\hat{K}}_{32} & {\hat{K}}_{33}^{( 1 )} + {\hat{K}}_{33}^{( 2 )}\end{matrix} ] \{ \begin{matrix}\begin{matrix}{u}_{1}^{n + 1} \\ {u}_{2}^{n + 1}\end{matrix} \\ {u}_{3}^{n + 1}\end{matrix} \} = \{ \begin{matrix}{b}_{1} \\ {b}_{2} \\ {b}_{3}^{( 1 )} + {b}_{3}^{( 2 )} + {g}_{3}^{( 1 )} + {g}_{3}^{( 2 )}\end{matrix} \} \\ wherein \\ {\hat{K}}_{i j} = \frac{1}{Δ t} {M}_{i j} + {θ}_{i} {K}_{ij} , i , j = 1 , 2 , \\ {\hat{K}}_{3 j} = {θ}_{j} {K}_{3 j} , j = 1 , 2 , \\ {\hat{K}}_{33}^{( i )} = \frac{1}{Δ t} {M}_{33}^{( i )} + {θ}_{i} {K}_{33}^{( i )} , \\ {b}_{i} = {f}_{i} + \frac{1}{Δ t} {M}_{ii} {u}_{i}^{n} - ( 1 - {θ}_{i} ) {K}_{ii} {u}_{i}^{n} - ( 1 - {θ}_{i} ) {K}_{i 3} {u}_{3}^{n} , i = 1 , 2 , \\ {b}_{3}^{( i )} = {f}_{3}^{( i )} + \frac{1}{Δ t} {M}_{33} {u}_{3}^{n} - ( 1 - {θ}_{i} ) {K}_{3 i} {u}_{i}^{n} - ( 1 - {θ}_{i} ) {K}_{33}^{( i )} {u}_{3}^{n} , i = 1 , 2 , \qquad ( C3 )$$

wherein the superscript (i) denotes a matrix or vector of the interface on the side of the subdomain Ωᵢ. Mᵢᵢ (i=1, 2) represents a positive definite capacity matrix of the subdomain Ωᵢ, Kᵢᵢ(i=1,2) is a semi-definite conductivity matrix of subdomain Ωᵢ, Kᵢ₃, K₃ᵢ and K₃₃⁽ⁱ⁾ (i=1,2) are local conductivity matrixes of the interface, M₃₃ represents a combined capacity matrix at the interface of the two subdomains and M₃₃=M₃₃⁽¹⁾+M₃₃⁽²⁾, g₃⁽¹⁾ and g₃⁽²⁾ are a discretized flux of the Robin boundary condition assigned on the interface of Γ₁₂^{IN} with g₃⁽¹⁾=−g₃⁽²⁾, f₃ represents an added volumetric heat source on the interior elements along the interface of Γ₁₂^{IN} and f₃=f₃⁽¹⁾+f₃⁽²⁾, and f₃⁽¹⁾ and f₃⁽²⁾ are volumetric heat source on the interface of Γ₁₂^{IN} from the sides of subdomains Ω₁ and Ω₂, respectively;

applying, for the DR coupling, the Dirichlet boundary condition on interface Γ₁₂^{IN} for subdomain Ω₁, and adding the Robin boundary condition on the interface Γ₁₂^{IN} for subdomain Ω₂, so as to split the discretization in Eq. (C3) into

$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \} \qquad ( C4 )$$

for subdomain Ω₁, and

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \} \qquad ( C4 )$$

for subdomain Ω₂, wherein \tilde{g}₃⁽²⁾ denotes an augmented flux on the interface Γ₁₂^{IN}, A₃₃⁽²⁾ is an augmentation matrix for the Robin boundary condition based on the governing equation in Eq. (C2), and is determined by the Robin coefficient αᵢⱼ in Eq. (C1); and

applying a Dirichlet-Robin iteration method to solve the discretization equations of Eqs. (C4) and (C5) for the multi-time step until the solution is converged, wherein the multi-time step comprises a system timestep Δtₛ, one subdomain is updated with the system timestep Δt₁=Δtₛ while another subdomain is updated with the timestep Δt₂=Δtₛ/nₚ, and wherein the system time updates after all the time integrations in the subdomains are completed.

In one embodiment, the boundary F comprises two complementary boundaries Γ=Γ_{D}∪Γ_{N} and Γ_{D}∩Γ_{N}=ø, wherein Γ_{D} donates the Dirichlet boundary condition that is a temperature boundary condition, and Γ_{N} donates the Neumann boundary condition that is a heat flux boundary condition.

In one embodiment, the time integration form of the temperature filed in one subdomain satisfies the relationship of

$${u}_{i}^{n + θ} = ( 1 - {θ}_{i} ) {u}_{i}^{n} + {θ}_{i} {u}_{i}^{n + 1}$$

wherein the superscript n represents an iteration number of time step while subscript i denotes the variable belongs to subdomain Ωᵢ, (i=1, 2), θᵢ is a coefficient used to evaluate influences of different time schemes on the current value and 0≤θᵢ≤1, uᵢ^{n+θ} represents the temperature obtained by a mixed time scheme, uᵢⁿ is the temperature value at the n-th time step, and uᵢⁿ⁺¹ denotes the temperature value at the (n+1)-th time step.

In one embodiment, when θᵢ=0, the time integrators are a forward Euler, while when θᵢ=1, the time integrators are a backward Euler.

In one embodiment, the Dirichlet-Robin iteration method comprises:

(a) for a given temperature distribution u₃^{(1),n} at the interface Γ₁₂^{IN}, solving the discretization function of Eq. (C5) in subdomain Ω₁ with the Dirichlet boundary condition u_{Γ}_{₁₂}_{^{In}}=u₃^{(1),n} on the interface Γ₁₂^{IN}, so as to obtain the temperature in subdomain Ω₁, u₁ⁿ=\hat{K}₁₁⁻¹(b₁−\hat{K}₁₃u₃^{(1),n});

(b) computing the flux on the interface Γ₁₂^{IN} using g₃⁽¹⁾=S⁽¹⁾u₃^{(1),n}−C₃⁽¹⁾, wherein S⁽¹⁾=\hat{K}₃₃⁽¹⁾−\hat{K}₃₁\hat{K}₁₁⁻¹\hat{K}₁₃ is the Schur complement matrix and includes both the mass and timestep terms, and C₃⁽¹⁾=b₃⁽¹⁾−\hat{K}₃₁\hat{K}₁₁⁻¹b₁ is a source term for grouping the influence of an external heat source;

(c) obtaining, based on the flux g₃⁽¹⁾ and Eq. (C6), the augmented flux \tilde{g}₃⁽²⁾ on subdomain Ω₂ by g₃⁽²⁾=−g₃⁽¹⁾,

$${\tilde{g}}_{3}^{( 2 )} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1} \qquad ( C6 )$$

wherein A₃₃⁽²⁾u₃^{(2),n+1} is the Robin augmented term for imposing the Robin boundary condition on the interface Γ₁₂^{IN}, and the magnitude of the augmented flux remains constant during the subcycling of the timestep Δt₂, and solving the following discretized equation for each p until pΔt₂=Δtₛ:

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + 1 , p + 1}\end{matrix} \} = \{ \begin{matrix}{b}_{2} \\ {b}_{3}^{( 2 )} - {g}_{3}^{( 1 )} + {A}_{33}^{( 2 )} {u}_{3}^{( 2 ) , n + 1 , p}\end{matrix} \} \qquad ( C7 )$$

so as to obtain the temperature in subdomain Ω₂, wherein vectors u₂^{n+1,p+1} and u₃^{(2),n+1,p+1} represent the temperature in subdomain Ω₂ and the temperature on the interface Γ₁₂^{IN} at p^{th} subtimestep of n^{th} system timestep, respectively; and

(d) once the subcycling in subdomain Ω₂ is finished, setting the temperature of the interface Γ₁₂^{IN} on the side of subdomain Ω₁ to be u₃^{(1),n+1}=u₃^{(2),n+1}, and returning to step (a) and continuing the iteration for both the system timestep and the subdomain timestep until the temperature solution is converged.

In one embodiment, the augmented Robin term is a function of time step, relative material properties and spatial mesh size, and is close to an optimal value.

In one embodiment, the method further comprises obtaining an optimal approximation for the Schur complement matrix by analyzing a one-dimensional (1D) heat transfer problem; and extending the optimal approximation to multiple dimensions including two-dimensional (2D) or three-dimensional (3D) problems.

In one embodiment, the step of obtaining the optimal approximation comprises approximating A₃₃ with a scalar value of α for the 1D problem; and approximating the Schur complement matrix S⁽¹⁾ in the 1D problem by the scalar value of α, which is a function of the material property, spatial discretization and timestep, wherein the scalar value of α (the Robin parameter) for the 1D problem is

$$α = {S}^{( 1 )} \approx \frac{{k}_{1}}{{h}_{1}} {( {χ}^{2} + 2 {θ}_{1} χ )}^{1 / 2} , \\ wherein \\ χ = {θ}_{1} \hat{χ} = \frac{{ρ}_{1} {c}_{1} {h}_{1}^{2}}{2 {k}_{1} Δ {t}_{1}} . \qquad ( C8 )$$

In one embodiment, the step of extending the optimal approximation comprises approximating the Schur complement matrix by a diagonal matrix for 2D or 3D problems, wherein the diagonal values of the diagonal matrix are computed based on the definition of the Robin parameter in Eq. (C8) for each node on the shared interface.

In one embodiment, when A₃₃=S⁽¹⁾, the timestep iteration converges in one iteration.

In one embodiment, the method is applicable for additive manufacturing (AM).

In one embodiment, method is capable of capturing a large temperature gradient around a melting pool region with one-hundred times acceleration.

In another aspect of the invention, the method for accelerating simulation of transient heat conduction includes:

decomposing a solution domain into a set of subdomains, wherein a share boundary of two neighbor subdomains defines an interface therebetween;

coupling the two neighbor subdomains at the interface with a Dirichlet-Robin (DR) coupling that comprises a Robin parameter used to guarantee the continuity of the Robin boundary;

obtaining governing equations of the transient heat conduction for each subdomain with the DR coupling by applying the Dirichlet boundary condition on one side of interface for one of two neighbor subdomains and adding the Robin boundary condition on the other side of the interface for the other of two neighbor subdomains, wherein the governing equations comprises a Schur complement matrix that includes both the mass and timestep terms, and an augmented matrix that is determined by the Robin parameter;

obtaining an approximation of the augmented matrix, and assigning the approximated augmented matrix to the Schur complement matrix; and

applying a Dirichlet-Robin iteration method to solve the governing equations for the multi-time step until the solution is converged.

In one embodiment, when the augmented matrix is equal to the Schur complement matrix, the timestep iteration converges in one iteration.

In one embodiment, the DR coupling on the interface satisfies

$${k}_{i} \frac{\partial {u}_{i}}{\partial {n}_{i}} + {α}_{i j} {u}_{i} = - {k}_{j} \frac{\partial {u}_{j}}{\partial {n}_{j}} + {α}_{i j} {u}_{j} , on {Γ}_{i j}^{In}$$

wherein αᵢⱼ is the Robin parameter, uᵢ is a temperature field at the subdomains Ωᵢ, nᵢ is a unit normal vector at the Neumann boundary of the subdomains Ωᵢ, and kᵢ is thermal conductivity of a material at the subdomains Ωᵢ.

In one embodiment, the governing equations of the transient heat conduction for each subdomain comprise

$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \}$$

for subdomain Ω₁, and

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \}$$

for subdomain Ω₂, wherein \tilde{g}₃⁽²⁾ denotes an augmented flux on the interface, A₃₃⁽²⁾ is the augmentation matrix.

In one embodiment, the augmented Robin term A₃₃⁽²⁾u₃^{(2),n+1} is a function of time step, relative material properties and spatial mesh size, and is close to an optimal value.

In one embodiment, the step of obtaining the approximation of the augmented matrix comprises approximating the augmented matrix with a scalar for a 1D case; and extending it to a 2D/3D case by a diagonal matrix.

In one embodiment, the approximated Schur complement matrix S⁽¹⁾ in the 1D problem is the scalar value of α,

$$α = {S}^{( 1 )} \approx \frac{{k}_{1}}{{h}_{1}} {( {χ}^{2} + 2 {θ}_{1} χ )}^{1 / 2} , \\ wherein$$

$$χ = {θ}_{1} \hat{χ} = \frac{{ρ}_{1} {c}_{1} {h}_{1}^{2}}{2 {k}_{1} Δ {t}_{1}} .$$

In one embodiment, the step of extending the approximation to a 2D/3D case comprises approximating the Schur complement matrix by a diagonal matrix for 2D or 3D problems, wherein the diagonal values of the diagonal matrix are computed based on the definition of the Robin parameter in Eq. (C8) for each node on the shared interface.

In one embodiment, the Dirichlet-Robin iteration method comprises:

(a) for a given temperature distribution u₃^{(1),n} at the interface Γ₁₂^{IN}, solving the discretization function of Eq. (C5) in subdomain Ω₁ with the Dirichlet boundary condition u_{Γ}_{₁₂}_{^{In}}=u₃^{(1),n} on the interface Γ₁₂^{IN}, so as to obtain the temperature in subdomain Ω₁, u₁ⁿ=\hat{K}₁₁⁻¹(b₁−\hat{K}₁₃u₃^{(1),n});

(b) computing the flux on the interface Γ₁₂^{IN} using g₃⁽¹⁾=S⁽¹⁾u₃^{(1),n}−C₃⁽¹⁾, wherein S⁽¹⁾=\hat{K}₃₃⁽¹⁾−\hat{K}₃₁\hat{K}₁₁⁻¹\hat{K}₁₃ is the Schur complement matrix and includes both the mass and timestep terms, and C₃⁽¹⁾=b₃⁽¹⁾−\hat{K}₃₁\hat{K}₁₁⁻¹b₁ is a source term for grouping the influence of an external heat source;

(c) obtaining, based on the flux g₃⁽¹⁾ and Eq. (C6), the augmented flux \tilde{g}₃⁽²⁾ on subdomain Ω₂ by g₃⁽²⁾=−g₃⁽¹⁾,

$${\tilde{g}}_{3}^{( 2 )} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1}$$

wherein A₃₃⁽²⁾u₃^{(2),n+1} is the augmented term for imposing the Robin boundary condition on the interface Γ₁₂^{IN}, and the magnitude of the modified flux remains constant during the subcycling of the timestep Δt₂, and solving the following discretized equation for each p until pΔt₂=Δtₛ:

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + 1 , p + 1}\end{matrix} \} = \{ \begin{matrix}{b}_{2} \\ {b}_{3}^{( 2 )} - {g}_{3}^{( 1 )} + {A}_{33}^{( 2 )} {u}_{3}^{( 2 ) , n + 1 , p}\end{matrix} \}$$

so as to obtain the temperature in subdomain Ω₂, wherein vectors u₂^{n+1,p+1} and u₃^{(2),n+1,p+1} represent the temperature in subdomain Ω₂ and the temperature on the interface Γ₁₂^{IN} at p^{th} subtimestep of n^{th} system timestep, respectively; and

(d) once the subcycling in subdomain Ω₂ is finished, setting the temperature of the interface Γ₁₂^{IN} on the side of subdomain Ω₁ to be u₃^{(1),n+1}=u₃^{(2),n+1}, and returning to step (a) and continuing the iteration for both the system timestep and the subdomain timestep until the temperature solution is converged.

The method is robust and stable for heterogenous material distribution.

In yet another aspect, the invention relates to a non-transitory tangible computer-readable medium storing instructions which, when executed by one or more processors, cause a system to perform the above-disclosed method.

In a further aspect, the invention relates to system for accelerating simulation of transient heat conduction comprising one or more processors configured to operably perform the above-disclosed method.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows a general domain of heat transfer.

FIG. 2 shows an example of domain decomposition. The original domain Ω is divided into two subdomains, Ω=Ω₁+Ω₂, and an interior boundary Γ₁₂^{IN} is generated across the interface of the two subdomains, Γ₁₂^{IN}=∂Ω₁∩∂Ω₂.

FIG. 3 shows a 1D model for the investigation for the approximation of Schur complement matrix.

FIG. 4 shows stability of 1D problem for different α/S₁ and S₂/S₁.

FIG. 5 shows a numerical example used to examine performance of the novel DR coupling scheme over the DN coupling scheme.

FIG. 6 shows temperature distributions of horizontal midline at the time steps t=0.05, t=0.1, t=0.2 and t=0.3 with different α values. Panel (a): Temperature at t=0.05. Panel (b): Temperature at t=0.1. Panel (c): Temperature at t=0.2. Panel (d): Temperature at t=0.3.

FIG. 7 shows temperature distributions of the two cross sections at the time steps t=0.05, t=0.1 and t=0.2 for the Scheme 1. Panel (a): Temperature at the horizontal midline. Panel (b): Temperature at the domain interface.

FIG. 8 shows temperature distributions of the two cross sections at the time steps t=0.05, t=0.1 and t=0.2 for the Scheme 2. Panel (a): Temperature at the horizontal interface. Panel (b): Temperature at the domain interface.

FIG. 9 shows temperature distributions of the two cross sections at the time steps t=0.01, t=0.015 and t=0.02 for the Scheme 3. Panel (a): Temperature at the horizontal interface. Panel (b): Temperature at the domain interface.

FIG. 10 shows surface plots for the temperature distributions obtained by the implicit, DR and DN schemes at the time t=0.01, t=0.015 and t=0.02.

FIG. 11 shows a numerical model of Case 1 for accuracy and convergence study for DR coupling scheme

FIG. 12 shows an exact solution and numerical solution of the temperature distribution for the problem at time steps t=0.2, t=0.4 and t=0.6 with element size

$$Δ x = \frac{1}{60} and Δ t = 0.1 \times \frac{1}{4} .$$

FIG. 13 shows L₂ norm error of the novel DR coupling scheme for the problem in Eq. (45)-(47) with respect to different time step and mesh discretization.

FIG. 14 shows convergence study of the DR coupling with accurate Schur Matrix

FIG. 15 shows a model for investigation of the novel DR coupling for different time integrations.

FIG. 16 shows L₂ error of different time integration scheme versus n_{cycle} at t=0.4 s. Panel (a): Convergence of the L₂ relative error. Panel (b): Temperature distribution at time step t=0.4 s by the explicit-explicit time integration scheme without coupling.

FIG. 17 shows an error estimation of the four-time integration schemes with different field ratio at t=1.0 s.

FIG. 18 shows temperature distributions at the center line along y-direction for the four-time integration schemes with different field ratio γ at t=1.0 s, comparing to explicit time scheme with small time step. Panel (a): Comparison between exp-exp with fully coupled exp. Panel (b): Comparison between exp-imp with fully coupled exp. Panel (c): Comparison between imp-exp with fully coupled exp. Panel (d): Comparison between imp-imp with fully coupled exp.

FIG. 19 shows a 2D simulation model for laser-based additive manufacturing

FIG. 20 shows a dimension of region 2 for the three-time schemes. Panel (a): Δt₁=20Δt₂. Panel (b): Δt₁=50Δt₂. Panel (c): Δt₁=100Δt₂.

FIG. 21 shows temperature distribution at time t=0.52 by using the reference simulation through implicit scheme with Δt₁=Δt₀.

FIG. 22 shows temperature distributions at time t=0.52 by using both implicit-explicit DR coupling and the implicit without DR coupling for Δt₁=20Δt₀. Panel (a): Temperature distribution obtained by implicit-explicit DR coupling. Panel (b): Temperature distribution obtained by line heat source model. Panel (c): Temperature at the centerline of y-direction.

FIG. 23 shows temperature distributions at time t=0.52 by using both implicit-explicit DR coupling and the implicit without DR coupling for Δt₁=50Δt₀. Panel (a): Temperature distribution obtained by implicit-explicit DR coupling. Panel (b): Temperature distribution obtained by line heat source model. Panel (c): Temperature at the centerline of y-direction.

FIG. 24 shows temperature distributions at time t=0.52 by using both implicit-explicit DR coupling and the implicit without DR coupling for Δt₁=100Δt₀. Panel (a): Temperature distribution obtained by implicit-explicit DR coupling. Panel (b): Temperature distribution obtained by line heat source model. Panel (c): Temperature at the centerline of y-direction.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed may be resorted to by those skilled in the art, and that such modifications and variations are considered to be within the scope of this invention as defined by the appended claims.

Whenever a range is given in the specification, for example, a temperature range, a time range, or a composition or concentration range, all intermediate ranges and subranges, as well as all individual values included in the ranges given are intended to be included in the invention. It will be understood that any subranges or individual values in a range or subrange that are included in the description herein can be excluded from the claims herein.

It will be understood that, as used in the description herein and throughout the claims that follow, the meaning of “a”, “an”, and “the” includes plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising”, or “includes” and/or “including”, or “has” and/or “having”, or “carry” and/or “carrying”, or “contain” and/or “containing”, or “involve” and/or “involving”, “characterized by”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used in the disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in the disclosure, the phrase “at least one of A, B, and C” should be construed to mean a logical (A or B or C), using a non-exclusive logical OR. As used herein, the term “and/or” includes any and all combinations of one or more of the associated listed items.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

The quality of additively manufactured metal parts depends strongly on the space- and time-varying temperature throughout the parts as metal is melted and resolidified. Computational simulation of this process is key to the prediction of this temperature and the optimization of part and process designs. However, simulation is made very difficult by the fact that this process has multiple time scales: phenomena near the laser takes place on the scale of microseconds, while the entire build may take several hours. Due to the underlying complexity, it is extremely time-consuming to perform detailed simulation when desirable accuracy is required. Simulation of the entire process using traditional computational methods is not feasible.

One of the objectives of this invention is to develop a multi-time stepping (i.e., multiple time-scale) method based on the Schur complement matrix approximation to accelerate the transient heat conduction simulation. Instead of using the Dirichlet-Neumann method, a Robin iteration method is employed in the novel method to achieve the continuity of the interfaces among different subdomains. This enables stability of the multi-time stepping modeling with heterogeneous materials on both sides of the subdomain interfaces. Specifically, a systematic way is disclosed to obtain the optimal approximation for the Schur complement matrix by analyzing a one-dimensional (1D) problem. This allows more accurate representation of the Schur complement matrix and avoids the stability issue caused by artificial relaxation parameters in the Dirichlet-Neumann iteration method. Due to the desirable unconditional stability, the novel method for transient heat conduction only requires one iteration to reach convergence. Several numerical examples are developed to study the stability, convergence and applicability to investigate the performance of the novel method. By comparing with the conventional Neumann iteration method, it is found that the novel method is robust and stable for heterogenous material distribution. Specifically, a simulation representative of a single track for additive manufacturing is performed and compared with a line heat source model approach. It is found that the novel method of the invention not only accelerates the simulation hundreds of times, but guarantees the accuracy of the melting pool region as well.

The multiple time-scale method separates the fast timescale region from the region of slower thermal response, and uses a new method to accurately and stably couple the two regions together, which allows a small part of the domain to be simulated using a fine mesh and small time step, while the remained uses a coarse mesh and much larger timestep, thereby enabling efficient simulation of the entire build process.

In one aspect of the invention, the method for accelerating simulation of transient heat conduction comprises:

dividing a domain Ω of transient heat transfer bounded by a boundary of Γ into a set of subdomains {Ωᵢ}, wherein a share boundary of two neighbor subdomains Ωᵢ and Ωⱼ defines an interface Γᵢⱼ^{In} between the two neighbor subdomains Ωᵢ and Ωⱼ;

obtaining a Dirichlet-Robin (DR) coupling on the interface Γᵢⱼ^{In} as

$${k}_{i} \frac{\partial {u}_{i}}{\partial {n}_{i}} + {α}_{i j} {u}_{i} = - {k}_{j} \frac{\partial {u}_{j}}{\partial {n}_{j}} + {α}_{i j} {u}_{j} , on {Γ}_{i j}^{In} \qquad ( C1 )$$

wherein αᵢⱼ is a coefficient to guarantee continuity of the Robin boundary, uᵢ is a temperature field at the subdomains Ωᵢ, nᵢ is a unit normal vector at the Neumann boundary of the subdomains Ωᵢ, and kᵢ is thermal conductivity of a material at the subdomains Ωᵢ;

obtaining a governing equation of the transient heat conduction in the domain Ω by using the DR coupling as

$${\sum }_{i} {\int }_{{Ω}_{i}} {v}_{i} ρ {c}_{p} {\dot{u}}_{i} d Ω + {\sum }_{i} {\int }_{Ω} ∇ {v}_{i} \cdot {k}_{i} ∇ {u}_{i} d Ω + {\sum }_{i} {\sum }_{j} {\int }_{{Γ}_{ij}^{In}} {v}_{i} ( {u}_{i} - {u}_{j} ) {α}_{i j} d Γ + {\sum }_{i} {\sum }_{j} {\int }_{{Γ}_{ij}^{In}} {v}_{i} ( {k}_{i} \frac{\partial {u}_{i}}{\partial {n}_{i}} + {k}_{j} \frac{\partial {u}_{j}}{\partial {n}_{j}} ) dΓ = {\sum }_{i} {\int }_{{Ω}_{i}} {v}_{i} {Q}_{i} d Ω - {\int }_{{Γ}_{N}} v {q}_{{Γ}_{N}} d Γ \qquad ( C2 )$$

where a superposed dot denotes a time derivative, ∇ is a gradient operator, ρ is a density of the material, cₚ represents a specific heat, and q_{Γ}_{_{N}} denotes a heat flux subjected to the Neumann boundary;

focusing on a particular i-j pair, and without loss of generality denote the two bordering regions as 1 and 2; after discretizing using finite elements in space, partitioning arrays of unknowns at nodes, discretizing in time, and using subscript 3 to denote nodes on the interface itself, resulting in governing equation Eq. (C2) for the subdomains in a form of

$$[ \begin{matrix}{\hat{K}}_{11} & 0 & {\hat{K}}_{13} \\ 0 & {\hat{K}}_{22} & {\hat{K}}_{23} \\ {\hat{K}}_{31} & {\hat{K}}_{32} & {\hat{K}}_{33}^{( 1 )} + {\hat{K}}_{33}^{( 2 )}\end{matrix} ] \{ \begin{matrix}{u}_{1}^{n + 1} \\ {u}_{2}^{n + 1} \\ {u}_{3}^{n + 1}\end{matrix} \} = \{ \begin{matrix}{b}_{1} \\ {b}_{2} \\ {b}_{3}^{( 1 )} + {b}_{3}^{( 2 )} + {g}_{3}^{( 1 )} + {g}_{3}^{( 2 )}\end{matrix} \} \\ wherein \\ {\hat{K}}_{i j} = \frac{1}{Δ t} {M}_{i j} + {θ}_{i} {K}_{ij} , i , j = 1 , 2 , \\ {\hat{K}}_{3 j} = {θ}_{j} {K}_{3 j} , j = 1 , 2 , \\ {\hat{K}}_{33}^{( i )} = \frac{1}{Δ t} {M}_{33}^{( i )} + {θ}_{i} {K}_{33}^{( i )} , \\ {b}_{i} = {f}_{i} + \frac{1}{Δ t} {M}_{i i} {u}_{i}^{n} - ( 1 - {θ}_{i} ) {K}_{i i} {u}_{i}^{n} - ( 1 - {θ}_{i} ) {K}_{i 3} {u}_{3}^{n} , i = 1 , 2 , \\ {b}_{3}^{( i )} = {f}_{3}^{( i )} + \frac{1}{Δ t} {M}_{33} {u}_{3}^{n} - ( 1 - {θ}_{i} ) {K}_{3 i} {u}_{i}^{n} - ( 1 - {θ}_{i} ) {K}_{33}^{( i )} {u}_{3}^{n} , i = 1 , 2 , \qquad ( C3 )$$

wherein the superscript (i) denotes a matrix or vector of the interface on the side of the subdomain Ωᵢ. Mᵢᵢ (i=1, 2) represents a positive definite capacity matrix of the subdomain Ωᵢ, Kᵢᵢ(i=1,2) is a semi-definite conductivity matrix of subdomain Ωᵢ, kᵢ₃, K₃ᵢ and K₃₃⁽ⁱ⁾ (i=1,2) are local conductivity matrixes of the interface, M₃₃ represents a combined capacity matrix at the interface of the two subdomains and M₃₃=M₃₃⁽¹⁾+M₃₃⁽²⁾, g₃⁽¹⁾ and g₃⁽²⁾ are a discretized flux of the Robin boundary condition assigned on the interface of Γ₁₂^{IN} with g₃⁽¹⁾=−g₃⁽²⁾, f₃ represents an added volumetric heat source on the interior elements along the interface of Γ₁₂^{IN} and f₃=f₃⁽¹⁾+f₃⁽²⁾, and f₃⁽¹⁾ and f₃⁽²⁾ are volumetric heat source on the interface of Γ₁₂^{IN} from the sides of subdomains Ω₁ and Ω₂, respectively;

applying, for the DR coupling, the Dirichlet boundary condition on interface Γ₁₂^{In} for subdomain Ω₁, and adding the Robin boundary condition on the interface Γ₁₂^{IN} for subdomain Ω₂, so as to split the discretization in Eq. (C3) into

$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \} \qquad ( C4 )$$

for subdomain Ω₁, and

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \} \qquad ( C5 )$$

for subdomain Ω₂, wherein \tilde{g}₃⁽²⁾ denotes an augmented flux on the interface Γ₁₂^{IN}, A₃₃⁽²⁾ is an augmentation matrix for the Robin boundary condition based on the governing equation in Eq. (C2), and is determined by the Robin coefficient αᵢⱼ in Eq. (C1); and

applying a Dirichlet-Robin iteration method to solve the discretization equations of Eqs. (C4) and (C5) for the multi-time step until the solution is converged, wherein the multi-time step comprises a system timestep Δtₛ, one subdomain is updated with the system timestep Δt₁=Δtₛ while another subdomain is updated with the timestep Δt₂=Δtₛ/nₚ, and wherein the system time updates after all the time integrations in the subdomains are completed.

In one embodiment, the boundary Γ comprises two complementary boundaries Γ=Γ_{D}∪Γ_{N} and Γ_{D}∩Γ_{N}=ø, wherein Γ_{D} donates the Dirichlet boundary condition that is a temperature boundary condition, and Γ_{N} donates the Neumann boundary condition that is a heat flux boundary condition.

In one embodiment, the time integration form of the temperature filed in one subdomain satisfies the relationship of

$${u}_{i}^{n + θ} = ( 1 - {θ}_{i} ) {u}_{i}^{n} + {θ}_{i} {u}_{i}^{n + 1}$$

wherein the superscript n represents an iteration number of time step while subscript i denotes the variable belongs to subdomain Ωᵢ, (i=1, 2), θᵢ is a coefficient used to evaluate influences of different time schemes on the current value and 0≤θᵢ≤1, uᵢ^{n+θ} represents the temperature obtained by a mixed time scheme, uᵢⁿ is the temperature value at the n-th time step, and uᵢⁿ⁺¹ denotes the temperature value at the (n+1)-th time step.

In one embodiment, when θᵢ=0, the time integrators are a forward Euler, while when θᵢ=1, the time integrators are a backward Euler.

In one embodiment, the Dirichlet-Robin iteration method comprises:

(a) for a given temperature distribution u₃^{(1),n} at the interface Γ₁₂^{IN}, solving the discretization function of Eq. (C5) in subdomain Ω₁ with the Dirichlet boundary condition u_{Γ}_{₁₂}_{^{In}}=u₃^{(1),n} on the interface Γ₁₂^{IN}, so as to obtain the temperature in subdomain Ω₁, u₁ⁿ=\hat{K}₁₁⁻¹(b₁−\hat{K}₁₃u₃^{(1),n});

(b) computing the flux on the interface Γ₁₂^{IN} using g₃⁽¹⁾=S⁽¹⁾u₃^{(1),n}−C₃⁽¹⁾, wherein S⁽¹⁾=\hat{K}₃₃⁽¹⁾−\hat{K}₃₁\hat{K}₁₁⁻¹\hat{K}₁₃ is the Schur complement matrix and includes both the mass and timestep terms, and C₃⁽¹⁾=b₃⁽¹⁾−\hat{K}₃₁\hat{K}₁₁⁻¹b₁ is a source term for grouping the influence of an external heat source;

(c) obtaining, based on the flux g₃⁽¹⁾ and Eq. (C6), the augmented flux \tilde{g}₃⁽²⁾ on subdomain Ω₂ by g₃⁽²⁾=−g₃⁽¹⁾,

$${\tilde{g}}_{3}^{( 2 )} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1} \qquad ( C6 )$$

wherein A₃₃⁽²⁾u₃^{(2),n+1} is the Robin augmented term for imposing the Robin boundary condition on the interface Γ₁₂^{IN}, and the magnitude of the augmented flux remains constant during the subcycling of the timestep Δt₂, and solving the following discretized equation for each p until pΔt₂=Δtₛ:

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + 1 , p + 1}\end{matrix} \} = \{ \begin{matrix}{b}_{2} \\ {b}_{3}^{( 2 )} - {g}_{3}^{( 1 )} + {A}_{33}^{( 2 )} {u}_{3}^{( 2 ) , n + 1 , p}\end{matrix} \} \qquad ( C7 )$$

so as to obtain the temperature in subdomain Ω₂, wherein vectors u₂^{n+1,p+1} and u₃^{(2),n+1,p+1} represent the temperature in subdomain Ω₂ and the temperature on the interface Γ₁₂^{IN} at p^{th} subtimestep of n^{th} system timestep, respectively; and

(d) once the subcycling in subdomain Ω₂ is finished, setting the temperature of the interface Γ₁₂^{IN} on the side of subdomain Ω₁ to be u₃^{(1),n+1}=u₃^{(2),n+1}, and returning to step (a) and continuing the iteration for both the system timestep and the subdomain timestep until the temperature solution is converged.

In one embodiment, the augmented Robin term is a function of time step, relative material properties and spatial mesh size, and is close to an optimal value.

In one embodiment, the method further comprises obtaining an optimal approximation for the Schur complement matrix by analyzing a one-dimensional (1D) heat transfer problem; and extending the optimal approximation to multiple dimensions including two-dimensional (2D) or three-dimensional (3D) problems.

In one embodiment, the step of obtaining the optimal approximation comprises approximating A₃₃ with a scalar value of a for the 1D problem; and approximating the Schur complement matrix S⁽¹⁾ in the 1D problem by the scalar value of α, which is a function of the material property, spatial discretization and timestep, wherein the scalar value of α (the Robin parameter) for the 1D problem is

$$α = {S}^{( 1 )} \approx \frac{{k}_{1}}{{h}_{1}} {( {χ}^{2} + 2 {θ}_{1} χ )}^{1 / 2} , \\ wherein \\ χ = {θ}_{1} \hat{χ} = \frac{{ρ}_{1} {c}_{1} {h}_{1}^{2}}{2 {k}_{1} Δ {t}_{1}} . \qquad ( C8 )$$

In one embodiment, the step of extending the optimal approximation comprises approximating the Schur complement matrix by a diagonal matrix for 2D or 3D problems, wherein the diagonal values of the diagonal matrix are computed based on the definition of the Robin parameter in Eq. (C8) for each node on the shared interface.

In one embodiment, when A₃₃=S⁽¹⁾, the timestep iteration converges in one iteration.

In one embodiment, the method is applicable for additive manufacturing (AM).

In one embodiment, method is capable of capturing a large temperature gradient around a melting pool region with one-hundred times acceleration.

In another aspect of the invention, the method for accelerating simulation of transient heat conduction includes:

decomposing a solution domain into a set of subdomains, wherein a share boundary of two neighbor subdomains defines an interface therebetween;

coupling the two neighbor subdomains at the interface with a Dirichlet-Robin (DR) coupling that comprises a Robin parameter used to guarantee the continuity of the Robin boundary;

obtaining governing equations of the transient heat conduction for each subdomain with the DR coupling by applying the Dirichlet boundary condition on one side of interface for one of two neighbor subdomains and adding the Robin boundary condition on the other side of the interface for the other of two neighbor subdomains, wherein the governing equations comprises a Schur complement matrix that includes both the mass and timestep terms, and an augmented matrix that is determined by the Robin parameter;

obtaining an approximation of the augmented matrix, and assigning the approximated augmented matrix to the Schur complement matrix; and

applying a Dirichlet-Robin iteration method to solve the governing equations for the multi-time step until the solution is converged.

In one embodiment, when the augmented matrix is equal to the Schur complement matrix, the timestep iteration converges in one iteration.

In one embodiment, the DR coupling on the interface satisfies

$${k}_{i} \frac{\partial {u}_{i}}{\partial {n}_{i}} + {α}_{i j} {u}_{i} = - {k}_{j} \frac{\partial {u}_{j}}{\partial {n}_{j}} + {α}_{i j} {u}_{j} , on {Γ}_{i j}^{In}$$

wherein αᵢⱼ is the Robin parameter, uᵢ is a temperature field at the subdomains Ωᵢ, nᵢ is a unit normal vector at the Neumann boundary of the subdomains Ωᵢ, and kᵢ is thermal conductivity of a material at the subdomains Ωᵢ.

In one embodiment, the governing equations of the transient heat conduction for each subdomain comprise

$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \}$$

for subdomain Ω₁, and

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \}$$

for subdomain Ω₂, wherein \tilde{g}₃^{(2 )} denotes an augmented flux on the interface, A₃₃⁽²⁾ is the augmentation matrix.

In one embodiment, the augmented Robin term A₃₃⁽²⁾u₃^{(2),n+1} is a function of time step, relative material properties and spatial mesh size, and is close to an optimal value.

In one embodiment, the step of obtaining the approximation of the augmented matrix comprises approximating the augmented matrix with a scalar for a 1D case; and extending it to a 2D/3D case by a diagonal matrix.

In one embodiment, the approximated Schur complement matrix S⁽¹⁾ in the 1D problem is the scalar value of α,

$$α = {S}^{( 1 )} \approx \frac{{k}_{1}}{{h}_{1}} {( {χ}^{2} + 2 {θ}_{1} χ )}^{1 \text{/} 2} , \\ wherein$$

$$χ = {θ}_{1} \hat{χ} = \frac{{ρ}_{1} {c}_{1} {h}_{1}^{2}}{2 {k}_{1} Δ {t}_{1}} .$$

In one embodiment, the step of extending the approximation to a 2D/3D case comprises approximating the Schur complement matrix by a diagonal matrix for 2D or 3D problems, wherein the diagonal values of the diagonal matrix are computed based on the definition of the Robin parameter in Eq. (C8) for each node on the shared interface.

In one embodiment, the Dirichlet-Robin iteration method comprises:

(a) for a given temperature distribution u₃^{(1),n} at the interface Γ₁₂^{IN}, solving the discretization function of Eq. (C5) in subdomain Ω₁ with the Dirichlet boundary condition u_{Γ}_{₁₂}_{^{In}}=u₃^{(1),n} on the interface Γ₁₂^{IN}, so as to obtain the temperature in subdomain Ω₁, u₁ⁿ=\hat{K}₁₁⁻¹(b₁−\hat{K}₁₂u₃^{(1),n});

(b) computing the flux on the interface Γ₁₂^{IN} using g₃⁽¹⁾=S⁽¹⁾U₃^{(1),n}−C₃⁽¹⁾, wherein S⁽¹⁾=\hat{K}₃₃⁽¹⁾−\hat{K}₃₁\hat{K}₁₁⁻¹\hat{K}₁₃ is the Schur complement matrix and includes both the mass and timestep terms, and C₃⁽¹⁾=b₃⁽¹⁾−\hat{K}₃₁\hat{K}₁₁⁻¹b₁ is a source term for grouping the influence of an external heat source;

(c) obtaining, based on the flux g₃⁽¹⁾ and Eq. (C6), the augmented flux \tilde{g}₃⁽²⁾ on subdomain Ω₂ by g₃⁽²⁾=−g₃⁽¹⁾,

$${\tilde{g}}_{3}^{( 2 )} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1}$$

wherein A₃₃⁽²⁾u₃^{(2),n+1} is the augmented term for imposing the Robin boundary condition on the interface Γ₁₂^{IN}, and the magnitude of the modified flux remains constant during the subcycling of the timestep Δt₂, and solving the following discretized equation for each p until pΔt₂=Δtₛ:

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + 1 , p + 1}\end{matrix} \} = \{ \begin{matrix}{b}_{2} \\ {b}_{3}^{( 2 )} - {g}_{3}^{( 1 )} + {A}_{33} {u}_{3}^{( 2 ) , n + 1 , p}\end{matrix} \}$$

so as to obtain the temperature in subdomain Ω₂, wherein vectors u₂^{n+1,p+1} and u₃^{(2),n+1,p+1} represent the temperature in subdomain Ω₂ and the temperature on the interface at Γ₁₂^{IN} at p^{th} subtimestep of n^{th} system timestep, respectively; and

(d) once the subcycling in subdomain Ω₂ is finished, setting the temperature of the interface Γ₁₂^{IN} on the side of subdomain Ω₁ to be u₃^{(1),n+1}=u₃^{(2),n+1}, and returning to step (a) and continuing the iteration for both the system timestep and the subdomain timestep until the temperature solution is converged.

The method is robust and stable for heterogenous material distribution.

In yet another aspect, the invention relates to system for accelerating simulation of transient heat conduction comprising one or more processors configured to operably perform the above-disclosed method.

It should be noted that all or a part of the steps according to the embodiments of the present invention is implemented by hardware or a program instructing relevant hardware. Yet another aspect of the invention provides a non-transitory tangible computer-readable medium storing instructions which, when executed by one or more processors, cause the mobile or transportable device to perform the above method for accelerating simulation of transient heat conduction. The computer executable instructions or program codes enable a computer or a similar computing system to complete various operations in the above disclosed method for privilege management. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, or other non-volatile solid state storage devices.

In certain embodiments, the GAMMA (Generalized Analysis of Multiscale and Multiphysics Applications) thermal simulation code implements this new technology for thermal simulation of additive manufacturing. The GAMMA uses the finite element method to solve the heat equation in part during the manufacturing process. The newest version includes the new multi-time stepping integration capability. Data storage, matrix formulation, matrix solution, parallelization schemes, I/O and other aspects of the software are the same as developed previously at Northwestern University except where they have been extended to handle multiple coupled domains using the new technology. Additionally, a prototype software code written in MATLAB® was used to test the technology in two dimensions for simple problem geometries.

Methods: The software code GAMMA uses the finite element method to solve the time-dependent heat equation in a part during an additive manufacturing process. At each time step, it assembles a sparse matrix system that is solved using an iterative solver to obtain an update to the temperature field and other variables throughout the geometry. The newest version uses a multiple-domain formulation with a novel coupling scheme at the interface to allow different timesteps in different regions of the part.

Hardware configuration: The GAMMA can be built to run on any computer that allows compilation of C++ code. It can be run on a single processor, or in parallel on systems with multiple CPUs.

Operating system: The GAMMA can be compiled and run under any operating system that allows compilation of C++ code. It has been demonstrated on Red Hat Linux, Ubuntu, and MacOS, or the likes.

Utilities: The GAMMA must be linked to the external matrix solver library PETSC. It also requires an MPI library and the mesh decomposition software METIS for parallel computations.

Open source: The GAMMA is not being distributed as part of an open source project.

Programming language: C++, or other programming languages.

Distribution format: Pre-built executable.

User friendliness: The GAMMA includes a User's Manual that describes the input file format. Multiple example problems are available that demonstrate mesh and input file formats, and can be run to demonstrate code capabilities. The new multi-time stepping capability is not yet captured in the documentation or example.

The invention may find widespread applications in additive manufacturing simulation, thermal simulation of parts and devices, thermal simulation of surface and interface phenomena, manufacturing process design, and so on.

The invention has, among other things, at least the following advantages: (1) uses a new coupling method based on a combination of fixed (Dirichlet) and mixed (Robin) conditions for a time-dependent problem; (2) applies coupling using a parameter newly derived to give optimal accuracy and stability; (3) formulates the multiple-region problem such that a much different time step can be used in each region; (4) formulates the coupling such that a different spatial discretization (mesh) size can be used in each region; (5) allows either an implicit or explicit time integration scheme individually in each region; and (6) a simulation software code that implements this new technology gains the capability to accelerate simulations of additive manufacturing processes, improving fidelity and predictive power and gaining an advantage over competitors. The market for this software capability includes additive machine manufacturers, as well as companies manufacturing parts for aerospace, defense, biomedical, and other industries.

These and other aspects of the present invention are further described below. Without intent to limit the scope of the invention, exemplary instruments, apparatus, methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### An Optimal Multi-Time Stepping Method for Transient Heat Conduction Simulation for Additive Manufacturing

One of the objectives of this exemplary study is to develop an efficient multi-time stepping methodology for transient heat conduction problem in order to accelerate the simulation with desirable accuracy at the small region of interest. In this example, the work of Roux et al. is extended to a time-dependent problem, such as transient heat transfer. Specifically, to achieve stable coupling and accelerate the convergence of Dirichlet-Robin iteration methods, a systematic method is developed to obtain the augmented Robin term based on the derivation from 1D problem.

The augmented Robin term is a function of time step, relative material properties and spatial mesh size, and is close to an optimal value. Based on this, an approximated augmented matrix to the Schur complement matrix is developed and substituted into the Dirichlet-Robin iteration method. This significantly reduces the computational cost for the Schur complement matrix and maintains the unconditional stable and rapid convergence characterization at the same time. To illustrate the superior performance of the novel methodology, several numerical examples are carried out to investigate the stability, convergence and applicability, respectively. In particular, the novel method is employed for additive manufacturing (AM) simulation and compared with the conventional line heat source model with large time step in implicit time integrators. It is found that the method disclosed herein is able to capture the large temperature gradient around melting pool region with one-hundred times acceleration.

As disclosed below, the basic transient heat conduction problem is formulated based on the multi-time stepping method with the novel Dirichlet-Robin iteration method in Section 1. Section 2 describes the process for the derivation of the approximated Schur complement matrix and the iterative scheme for the methodology. The numerical examples for investigation purpose are included in Section 3. Conclusions are drawn in Section 4.

### 1. Governing Equation for Transient Heat Transfer

The governing equation of the transient heat transfer is briefly reviewed first. The domain decomposition method based on the Dirichlet-Robin coupling is developed and derived in the weak form for a finite element method.

### 1.1. Model Problem

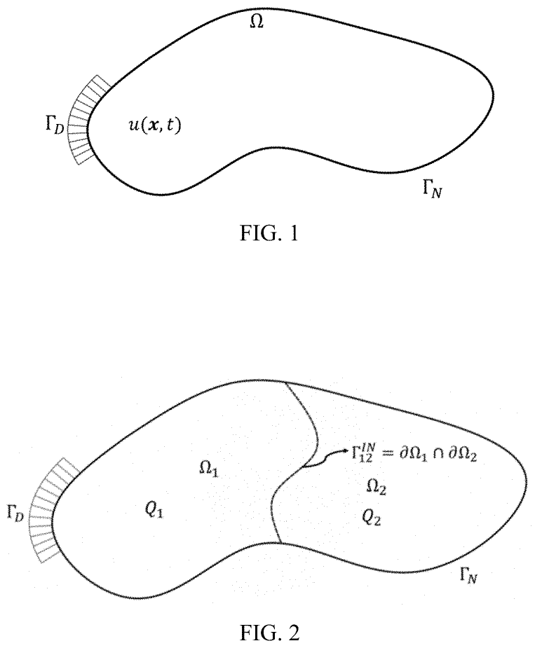

Consider an open domain Ω bounded by a boundary of Γ, as shown in FIG. 1. The boundary Γ is composed of two complementary boundaries Γ=Γ_{D}∪Γ_{N} and Γ_{D}∩Γ_{N}=ø, where Γ_{D} represents the Dirichlet boundary condition (i.e., temperature boundary condition) and Γ_{N} is the Neumann boundary condition (i.e., heat flux boundary condition). Variable t denotes the time and belongs to an open interval I, t∈I. The transient heat conduction problem can be formulated as

$$ρ {c}_{p} \dot{u} - ∇ \cdot ( k ∇ u ) = Q in Ω \qquad ( 1 )$$

with the initial and boundary conditions as

$$\begin{matrix}u ( x , 0 ) = {u}_{0} ( x ) in Ω & ( 2 ) \\ u ( x , t ) = {u}_{{Γ}_{D}} ( x , t ) on {Γ}_{D} \times I & ( 3 ) \\ - k ∇ u \cdot n = {q}_{{Γ}_{N}} ( x , t ) on {Γ}_{N} \times I & ( 4 )\end{matrix}$$

where x is the spatial coordinate and x∈Ω, u denotes the temperature field, the superposed dot in Eq. (1) denotes the time derivative and ∇ is the gradient operator, n represents the unit normal vector at the Neumann boundary Γ_{N}. Q(x, t) is the volumetric heat source, u₀(x) represents the initial temperature distribution of the domain Ω at t=0, u_{Γ}_{_{D}}(x, t) is the temperature on the boundary Γ_{D}, and q_{Γ}_{_{N}} denotes heat flux subjected to the Neumann boundary Γ_{N}. The density of the material is ρ, cₚ represents the specific heat, and k denotes the thermal conductivity of the material.

By using the Galerkin method, an arbitrary time-independent test function of v satisfying homogeneous boundary conditions on Γ_{D} is multiplied on both sides of Eq. (1) and integrated over the domain Ω:

$${\int }_{Ω} v ( ρ {c}_{p} \dot{u} - ∇ \cdot ( k ∇ u ) - f ) d Ω + {\int }_{{Γ}_{N}} v ( k ∇ u \cdot n + {q}_{{Γ}_{N}} ) d Ω = 0 \qquad ( 5 )$$

Through the variational principle, the transient heat conduction equations in Eqs. (1)-(4) can be reformulated into a bilinear weak form as

$$\begin{matrix}{\int }_{Ω} v ρ {c}_{p} \dot{u} d Ω + {\int }_{Ω} ∇ v \cdot k ∇ u d Ω = {\int }_{Ω} vQ d Ω - {\int }_{{Γ}_{N}} v ( k ∇ u \cdot n + {q}_{{Γ}_{N}} ) d Γ & ( 6 ) \\ u ( x , 0 ) = {u}_{0} ( x ) in Ω & ( 7 ) \\ u ( x , t ) = {u}_{{Γ}_{D}} ( x , t ) on {Γ}_{D} \times I & ( 8 )\end{matrix}$$

For a simulation problem like additive manufacturing, Eqs. (6)-(8) are used to solve the heat transfer in the manufacturing process.

In this exemplary embodiment, a multi-time stepping method is developed based on the Dirichlet-Robin (DR) coupling on the pseudo boundary to mitigate the cumbersome computation cost. For this purpose, the domain Ω is divided into a set of subdomains {Ωᵢ} as

$$Ω = {⋃}_{i = 1}^{{N}_{s}} \{ {Ω}_{i} \} \qquad ( 9 )$$

where Nₛ denotes the number of subdomains. The interface of the two neighbor subdomains in the set of {Ωᵢ} is denoted as

$${Γ}_{ij}^{In} = \partial {Ω}_{j} ⋂ \partial {Ω}_{j} , {Γ}^{In} = {⋃}_{i , j}^{{N}_{m}} {Γ}_{ij}^{In} \qquad ( 10 )$$

where Γᵢⱼ^{In} denotes the share boundary between subdomain Ωᵢ and subdomain Ωⱼ, Nₘ is the total number of interior boundaries. The continuous Dirichlet-Robin coupling can be formulated on the interface Γᵢⱼ^{In} as

$${k}_{i} \frac{\partial {u}_{i}}{\partial {n}_{i}} + {α}_{ij} {u}_{i} = - {k}_{j} \frac{\partial {u}_{j}}{\partial {n}_{j}} + {α}_{ij} {u}_{j} , on {Γ}_{ij}^{In} \qquad ( 11 )$$

where αᵢⱼ is a coefficient used to guarantee the continuity of the Robin boundary.

Substituting the Robin condition in Eq. (11) into the weak form in Eq. (6) and integrating Eq. (6) over the subdomains, one can obtain the governing equation as

$${Σ}_{i} {\int }_{{Ω}_{i}} {v}_{i} ρ {c}_{p} {\dot{u}}_{i} d Ω + {Σ}_{i} {\int }_{Ω} ∇ {v}_{i} \cdot {k}_{i} ∇ {u}_{i} d Ω + {Σ}_{i} {Σ}_{j} {\int }_{{Γ}_{ij}^{In}} {v}_{i} ( {u}_{i} - {u}_{j} ) {α}_{ij} d Γ + {Σ}_{i} {Σ}_{j} {\int }_{{Γ}_{ij}^{In}} {v}_{i} ( {k}_{i} \frac{\partial {u}_{i}}{\partial {n}_{i}} + {k}_{j} \frac{\partial {u}_{j}}{\partial {n}_{j}} ) d Γ = {Σ}_{i} {\int }_{{Ω}_{i}} {v}_{i} {Q}_{i} d Ω - {\int }_{{Γ}_{N}} {vq}_{{Γ}_{N}} d Γ \qquad ( 12 )$$

The transient heat conduction problem in the bilinear weak form can be expressed as

$$\begin{matrix}{( ρ {c}_{P} \dot{u} , v )}_{Ω} + a ( u , v , α ) = {( Q , v )}_{Ω} - {( {q}_{{Γ}_{N}} , v )}_{{Γ}_{N}} & ( 13 ) \\ u ( x , 0 ) = {u}_{0} ( x ) in Ω & ( 14 ) \\ u ( x , t ) = {u}_{{Γ}_{D}} ( x , t ) on {Γ}_{D} \times I & ( 15 )\end{matrix}$$

where α(⋅, ⋅) is the bilinear form and can be expressed as

$$a ( u , v ) = {\sum }_{i} {\int }_{Ω} ∇ {v}_{i} \cdot {k}_{i} ∇ {u}_{i} d Ω + {\sum }_{i} {\sum }_{j} {\int }_{{Γ}_{ij}^{In}} {v}_{i} ( {u}_{i} - {u}_{j} ) {α}_{ij} d Γ + {Σ}_{i} {Σ}_{j} {\int }_{{Γ}_{ij}^{In}} {v}_{i} ( {k}_{i} \frac{\partial {u}_{i}}{\partial {n}_{i}} + {k}_{j} \frac{\partial {u}_{j}}{\partial {n}_{j}} ) d Γ . \qquad ( 16 )$$

### 2. Discretization and Stability Analysis

In this section, a finite element method for solving the transient heat conduction problem by the multi-time stepping method is constructed. A simple problem of one interior boundary model is used as the example to present the detailed discretization and stability analysis. FIG. 2 shows an example of the domain decomposition. The original domain Ω is divided into two subdomains, Ω=Ω₁+Ω₂, and an interior boundary Γ₁₂^{IN} is generated across the interface of the two subdomains, Γ₁₂^{IN}=∂Ω₁∩∂Ω₂.

### 2.1. Discretization

In each subdomain, assuming that the transient heat conduction equation is solved separately with different integration schemes. The temperature in one subdomain can be written in a general time integration form as

$${u}_{i}^{n + θ} = ( 1 - {θ}_{i} ) {u}_{i}^{n} + {θ}_{i} {u}_{i}^{n + 1} \qquad ( 17 )$$

where the superscript n represents the iteration number of time step while subscript i denotes the variable belongs to subdomain i, (i=1, 2). θᵢ is a coefficient used to evaluate influences of different time schemes on the current value and 0≤θᵢ≤1. When θᵢ=0, the time integrators are forward Euler; while when θᵢ=1, the time integrators are backward Euler. uᵢ^{n+θ} represents the temperature obtained by the mixed time scheme, uᵢⁿ is the temperature value at time step n and uᵢⁿ⁺¹ denotes the value at time step n+1.

Based on the time integration in Eq. (17) and following the notation pattern in the work of Rouox and Garoud, the semi-discretization of the governing equation in Eq. (12) for two subdomains (or more than two subdomains, where subscripts 1 and 2 represent an arbitrary pair of neighboring subdomains) can be formulated in a monolithic form as

$$[ \begin{matrix}{M}_{11} & 0 & 0 \\ 0 & {M}_{22} & 0 \\ 0 & 0 & {M}_{33}\end{matrix} ] \{ \begin{matrix}\frac{1}{Δ t} ( {u}_{1}^{n + 1} - {u}_{1}^{n} ) \\ \frac{1}{Δ t} ( {u}_{2}^{n + 1} - {u}_{2}^{n} ) \\ \frac{1}{Δ t} ( {u}_{3}^{n + 1} - {u}_{3}^{n} )\end{matrix} \} + [ \begin{matrix}( 1 - {θ}_{1} ) {K}_{11} & 0 & ( 1 - {θ}_{1} ) {K}_{13} \\ 0 & ( 1 - {θ}_{2} ) {K}_{22} & ( 1 - {θ}_{2} ) {K}_{23} \\ ( 1 - {θ}_{1} ) {K}_{31} & ( 1 - {θ}_{2} ) {K}_{32} & ( 1 - {θ}_{1} ) {K}_{33}^{( 1 )} + ( 1 - {θ}_{2} ) {K}_{33}^{( 2 )}\end{matrix} ] \{ \begin{matrix}{u}_{1}^{n} \\ {u}_{2}^{n} \\ {u}_{3}^{n}\end{matrix} \} + [ \begin{matrix}{θ}_{1} {K}_{11} & 0 & {θ}_{1} {K}_{13} \\ 0 & {θ}_{2} {K}_{22} & {θ}_{2} {K}_{23} \\ {θ}_{1} {K}_{31} & {θ}_{2} {K}_{32} & {θ}_{1} {K}_{33}^{( 1 )} + {θ}_{2} {K}_{33}^{( 2 )}\end{matrix} ] \{ \begin{matrix}{u}_{1}^{n + 1} \\ {u}_{2}^{n + 1} \\ {u}_{3}^{n + 1}\end{matrix} \} = \{ \begin{matrix}{f}_{1} \\ {f}_{2} \\ {f}_{3} + {g}_{3}^{( 1 )} + {g}_{3}^{( 2 )}\end{matrix} \} \qquad ( 18 )$$

where the superscript (i) denotes the matrix or vector of the interface on the side of subdomain i. Mᵢᵢ (i=1, 2) represents the positive definite capacity matrix of subdomain i, Kᵢᵢ(i=1,2) is the semi-definite conductivity matrix of subdomain i, and Kᵢ₃, K₃ᵢ and K₃₃⁽ⁱ⁾ (i=1,2) are the local conductivity matrix of the interface. M₃₃ represents the combined capacity matrix at the interface of the two subdomains and M₃₃=M₃₃⁽¹⁾+M₃₃⁽²⁾, g₃⁽¹⁾ and g₃⁽²⁾ are the discretized flux of the Robin boundary condition assigned on the interface of Γ₁₂^{IN} with g₃⁽¹⁾=−g₃⁽²⁾, f₃ represents the added volumetric heat source on the interior elements along the interface of Γ₁₂^{IN} and f₃=f₃⁽¹⁾+f₃⁽²⁾, where f₃⁽¹⁾ and f₃⁽²⁾ are volumetric heat source on the interface of Γ₁₂^{IN} from the sides of subdomain 1 and 2, respectively. More details refer to the construction of matrixes Mᵢᵢ, Kᵢᵢ, Kᵢ₃ and K₃₃⁽ⁱ⁾ can be found in Hughes.

To simplify the symbols, Eq. (18) can be rewritten as

$$[ \begin{matrix}{\hat{K}}_{11} & 0 & {\hat{K}}_{13} \\ 0 & {\hat{K}}_{22} & {\hat{K}}_{23} \\ {\hat{K}}_{31} & {\hat{K}}_{32} & {\hat{K}}_{33}^{( 1 )} + {\hat{K}}_{33}^{( 2 )}\end{matrix} ] \{ \begin{matrix}{u}_{1}^{n + 1} \\ {u}_{2}^{n + 1} \\ {u}_{3}^{n + 1}\end{matrix} \} = \{ \begin{matrix}{b}_{1} \\ {b}_{2} \\ {b}_{3}^{( 1 )} + {b}_{3}^{( 2 )} + {g}_{3}^{( 1 )} + {g}_{3}^{( 2 )}\end{matrix} \} \\ where \\ {\hat{K}}_{i j} = \frac{1}{Δ t} {M}_{i j} + {θ}_{i} {K}_{ij} , i , j = 1 , 2 \\ {\hat{K}}_{3 j} = {θ}_{j} {K}_{3 j} , j = 1 , 2 \\ {\hat{K}}_{33}^{( i )} = \frac{1}{Δ t} {M}_{33}^{( i )} + {θ}_{i} {K}_{33}^{( i )} \\ {b}_{i} = {f}_{i} + \frac{1}{Δ t} {M}_{i i} {u}_{i}^{n} - ( 1 - {θ}_{i} ) {K}_{i i} {u}_{i}^{n} - ( 1 - {θ}_{i} ) {K}_{i 3} {u}_{3}^{n} , i = 1 , 2 \\ {b}_{3}^{( i )} = {f}_{3}^{( i )} + \frac{1}{Δ t} {M}_{33} {u}_{3}^{n} - ( 1 - {θ}_{i} ) {K}_{3 i} {u}_{i}^{n} - ( 1 - {θ}_{i} ) {K}_{33}^{( i )} {u}_{3}^{n} , i = 1 , 2 \qquad ( 19 )$$

For the DR coupling, suppose the Dirichlet boundary condition is applied on interface Γ₁₂^{IN} for subdomain 1, while the Robin boundary condition is added on the interface Γ₁₂^{IN} for subdomain 2, the monolithic discretization in Eq. (19) is thus split into two parts

$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \} \qquad ( 20 )$$

for subdomain 1 and

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \} \qquad ( 21 )$$

for subdomain 2, where \tilde{g}₃⁽²⁾ denotes the augmented flux on the interface Γ₁₂^{IN}, A₃₃⁽²⁾ is the augmentation matrix for the Robin boundary condition based on weak form of governing equation in Eq. (12). A₃₃⁽²⁾ is determined by the Robin parameter αᵢⱼ in the Eq. (11), which is difficult to obtain directly. In Section 2.2, a systematic way is disclosed to obtain optimal value of αᵢⱼ and the approximation of A₃₃⁽²⁾.

For subdomain 1, if u₃^{(1),n+1} were known (which in general it is not), then we could solve for u₁ⁿ⁺¹ by

$$( {u}_{1}^{n + 1} = {\hat{K}}_{11}^{- 1} ( {b}_{1} - {\hat{K}}_{13} {u}_{3}^{( 1 ) , n + 1} ) ) \qquad$$

Also, one can rearrange to obtain the flux g₃⁽¹⁾

$${g}_{3}^{( 1 )} = {\hat{K}}_{31} {u}_{1}^{n + 1} + {\hat{K}}_{33}^{( 1 )} {u}_{3}^{( 1 ) , n + 1} - {b}_{3}^{( 1 )} = {\hat{K}}_{31} {\hat{K}}_{11}^{- 1} ( {b}_{1} - {\hat{K}}_{13} {u}_{3}^{( 1 ) , n + 1} ) + {\hat{K}}_{33}^{( 1 )} {u}_{3}^{( 1 ) , n + 1} - {b}_{3}^{( 1 )} = \underbrace{( {\hat{K}}_{33}^{( 1 )} - {\hat{K}}_{31} {\hat{K}}_{11}^{- 1} {\hat{K}}_{13} )}_{{s}^{( 1 )}} {u}_{3}^{( 1 ) , n + 1} - \underbrace{( {b}_{3}^{( 1 )} - {\hat{K}}_{31} {\hat{K}}_{11}^{- 1} {b}_{1} )}_{{c}_{3}^{( 1 )}} \qquad ( 22 )$$

The matrix S⁽¹⁾=\hat{K}₃₃⁽¹⁾−\hat{K}₃₁\hat{K}₁₁⁻¹\hat{K}₁₃ is called the Schur complement matrix. In contrast with the related matrix Sⁱ in the work of Roux and Garaud, the matrix in this work includes both the mass and timestep terms. C₃⁽¹⁾=b₃⁽¹⁾−\hat{K}₃₁\hat{K}₁₁⁻¹b₁ is a source term used to group the influence of the external heat source. The flux g₃⁽¹⁾ can thus be compactly expressed as

$${g}_{3}^{( 1 )} = {S}^{( 1 )} {u}_{3}^{( 1 ) , n + 1} - {C}_{3}^{( 1 )} \qquad ( 23 )$$

For subdomain 2, following the derivation in Eqs. (22) and (23), the augmented flux added on the interface Γ₁₂^{In} can be expressed as

$${\tilde{g}}_{3}^{( 2 )} = {S}^{( 2 )} {u}_{3}^{( 2 ) , n + 1} - {C}_{3}^{( 2 )} + {A}_{33}^{( 2 )} {u}_{3}^{( 2 ) , n + 1} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1} \qquad ( 24 )$$

where S⁽²⁾ and C₃⁽²⁾ are the Schur complement matrix and source term for subdomain 2, and A₃₃⁽²⁾u₃^{(2),n+1} is the augmented term for imposing the Robin boundary condition on the interface Γ₁₂^{IN}.

In the multi-time stepping modeling, suppose there is a system timestep Δtₛ, the modeling in each subdomain can be integrated over the system timestep independently. The system time update after all the time integrations in the subdomains are completed. Taking the case with two domains as an example, it will be assumed that subdomain 1 is updated with the system timestep Δt₁=Δtₛ while subdomain 2 is updated with the timestep Δtₜ=Δtₛ/nₚ. This means that the timestep in subdomain 1 is nₚ times larger than subdomain 2, so that the temperature in subdomain 2 is updated nₚ times for every single update of subdomain 1.

Let n denote an intermediate system timestep and p denote a sub-timestep in subdomain 2. The Dirichlet-Robin iteration method for the multi-time step can thus be described as follows:
(1) For a given temperature distribution u₃^{(1),n} at the interface Γ₁₂^{In}, the discretization function of Eq. (20) is solved in subdomain 1 with the Dirichlet boundary condition u_{Γ}_{₁₂}_{^{In}}=u₃^{(1),n} on the interface Γ₁₂^{IN}.
(2) Compute the flux on the interface Γ₁₂^{IN} using Eq. (22), g₃⁽¹⁾=S⁽¹⁾u₃^{(1),n}−C₃⁽¹⁾.
(3) Based on the flux g₃⁽¹⁾, the flux added on subdomain 2 is obtained by g₃⁽²⁾=−g₃⁽¹⁾. The magnitude of the modified flux remains constant during the subcycling of the timestep Δt₂. To obtain the temperature in subdomain 2, the following discretized equation is solved for each p until pΔt₂=Δtₛ:

$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + {1}_{′} p + 1}\end{matrix} \} = \{ \begin{matrix}{b}_{2} \\ {b}_{3}^{( 2 )} - {g}_{3}^{( 1 )} + {A}_{33} {u}_{3}^{( 2 ) , n + 1 , p}\end{matrix} \} \qquad ( 25 )$$

wherein vectors u₂^{n+1,p+1} and u₃^{(2),n+1,p+1} represent the temperature in subdomain 2 and the temperature on the interface Γ₁₂^{IN} at p^{th} subtimestep of n^{th} system timestep, respectively.
(4) Once the subcycling in subdomain 2 is finished, the temperature of the interface Γ₁₂^{IN} on the side of subdomain 1 is set to be u₃^{(1),n+1=u}₃^{(2),n+1}. Then, we return to step (1) and continue the iteration for both the system timestep and the subdomain timestep until the problem is converged.

### 2.2. Stability Analysis and Convergence Study

Following the work of Roux and Garaud, the stability and convergence study for the

Robin interface matching conditions are conducted. By solving Eq. (25) in subdomain 2, one can obtain

$$\begin{matrix}{u}_{2}^{n + 1 , p + 1} = {\hat{K}}_{22}^{- 1} ( {b}_{2} - {\hat{K}}_{23} {u}_{3}^{( 2 ) , n + 1 , p + 1} ) & ( 26 ) \\ {\hat{K}}_{32} {u}_{2}^{n + 1 , p + 1} + ( {\hat{K}}_{33}^{( 2 )} + {A}_{33}^{( 2 )} ) {u}_{3}^{( 2 ) , n + 1 , p + 1} = {b}_{3}^{( 2 )} - {g}_{3}^{( 1 )} + {A}_{33}^{( 2 )} {u}_{3}^{( 2 ) , n + 1 , p} & ( 27 )\end{matrix}$$

Substitute Eqs. (26) and (24) into Eq. (21) and collect the temperature at the interior interface Γ₁₂^{IN} on the side of subdomain 2, we have

$$( {\hat{K}}_{33}^{( 2 )} - {\hat{K}}_{32} {\hat{K}}_{22}^{- 1} {\hat{K}}_{23} + {A}_{33}^{( 2 )} ) {u}_{3}^{( 2 ) , n + 1 , p + 1} = {b}_{3}^{( 2 )} - ( {S}^{( 1 )} {u}_{3}^{( 1 ) , n} - {C}_{3}^{( 1 )} ) + {A}_{33}^{( 2 )} {u}_{3}^{( 2 ) , n + 1 , p} - {\hat{K}}_{32} {\hat{K}}_{22}^{- 1} {b}_{2} \qquad ( 28 )$$

By using the symbols defined in Eq. (22) and u₃^{(1),n}=u₃^{(2),n+1,p}, Eq. (28) _{can be further rewritten as}

$$( {S}^{( 2 )} + {A}_{33}^{( 2 )} ) {u}_{3}^{( 2 ) , n + 1 , p + 1} = ( - {S}^{( 1 )} + {A}_{33}^{( 2 )} ) {u}_{3}^{( 2 ) , n + 1 , p} + {C}_{3}^{( 1 )} + {C}_{3}^{( 2 )} \\ where \\ {S}^{( 2 )} = {\hat{K}}_{33}^{( 2 )} - {\hat{K}}_{32} {\hat{K}}_{22}^{- 1} {\hat{K}}_{23} \\ and \\ {C}_{3}^{( 2 )} = {b}_{3}^{( 2 )} - {\hat{K}}_{32} {\hat{K}}_{22}^{- 1} {b}_{2} \qquad ( 29 )$$

When subdomain 1 and subdomain 2 are fully coupled, one has u₃^{n+1,p+1}=u₃^{(2),n+1,p}=u₃^{n+1,FC}, where u₃^{n+1,FC} denotes the temperature of the interface at timestep n for the fully coupled solution. Hence, Eq. (29) can be re-written as

$$( {S}^{( 1 )} + {S}^{( 2 )} ) {u}_{3}^{n + 1 , FC} = {C}_{3}^{( 1 )} + {C}_{3}^{( 2 )} \qquad ( 30 )$$

To study convergence, define the error in subcycling step p as

$${e}^{p} = {u}_{3}^{( 2 ) , n + 1 , p} - {u}_{3}^{n + 1 , FC} \qquad ( 31 )$$

The transformation of Eq. (30) can be written in the form of the error defined in Eq. (31) as

$$( {S}^{( 2 )} + {A}_{33}^{( 2 )} ) {u}_{3}^{( 2 ) , n + 1 , p + 1} - [ ( {S}^{( 2 )} + {A}_{33}^{( 2 )} ) - ( {A}_{33}^{( 2 )} - {S}^{( 1 )} ) ] {u}_{3}^{n + 1 , FC} = ( - {S}^{( 1 )} + {A}_{33}^{( 2 )} ) {u}_{3}^{( 2 ) , n + 1 , p} {e}^{p + 1} = - {( {S}^{( 2 )} + {A}_{33}^{( 2 )} )}^{- 1} ( {S}^{( 1 )} - {A}_{33}^{( 2 )} ) {e}^{p} \qquad ( 32 )$$

The convergence within the timestep iteration in subdomain 2 requires ∥e^{p+1}/e^{p}∥=∥(S⁽²⁾+A₃₃⁽²⁾)⁻¹ (S⁽¹⁾−A₃₃⁽²⁾)∥<1. When A₃₃⁽²⁾=S⁽¹⁾, the timestep iteration converges in one iteration.

Although Eq. (32) provides the convergence condition, the computational cost of the Schur complement matrix is very expensive considering the inverse of the matrix \hat{K}ᵢᵢ⁻¹ in Eq. (22).

To solve this problem, an approximation strategy is proposed to circumvent the computation of matrix inverse. From a 1D case, we approximate A₃₃⁽²⁾ with a scalar and extend it to 2D/3D by a diagonal matrix.

To calculate the scalar for 1D problem, we return to the definition:

$${S}^{( 1 )} = {\hat{K}}_{33}^{( 1 )} - {\hat{K}}_{31} {\hat{K}}_{11}^{- 1} {\hat{K}}_{13} \\ where \\ {\hat{K}}_{11} = \frac{1}{Δ t} {M}_{11} + {θ}_{1} {K}_{11} \\ {\hat{K}}_{13} = {θ}_{1} {K}_{13} \\ {\hat{K}}_{31} = {θ}_{1} {K}_{31} \\ {\hat{K}}_{33} = \frac{1}{Δ t} {M}_{33}^{( 1 )} + {θ}_{1} {K}_{33}^{( 1 )} \qquad ( 33 )$$

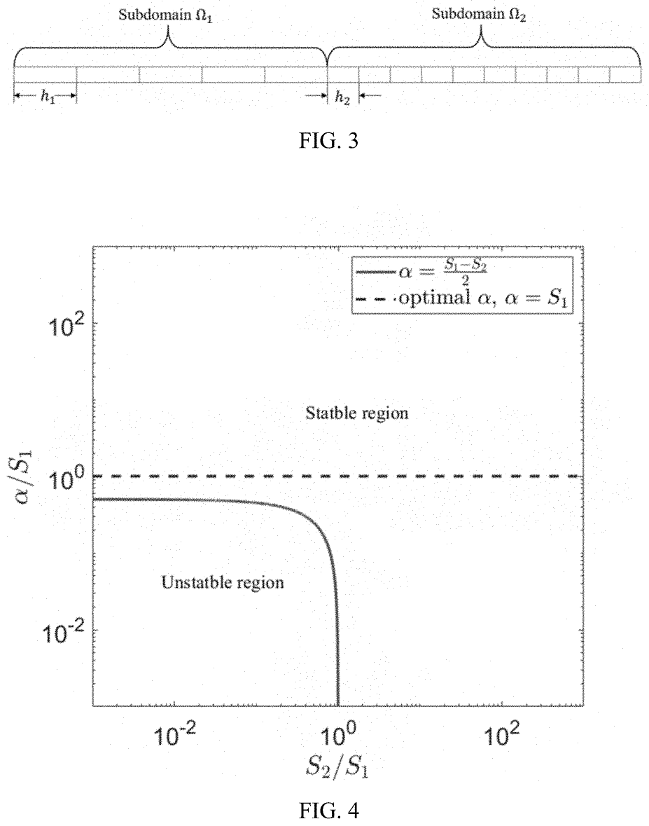

FIG. 3 shows a 1D model for the investigation for the approximation of the Schur complement matrix. Suppose we have a 1D problem and the setup is given in FIG. 3, the mesh size in subdomain 1 is Δx=h₁, the density is ρ₁, the thermal conductivity is c₁ and the timestep is Δt₁. Considering the forms of these matrices, we have

$$\begin{matrix}{\hat{K}}_{11} = \frac{1}{Δ t} {M}_{11} + {θ}_{1} {K}_{11} = [ \begin{matrix}a & b & 0 & 0 & ⋯ & ⋯ \\ b & a & b & 0 & ⋯ & ⋯ \\ 0 & b & a & b & ⋯ & ⋯ \\ 0 & 0 & b & a & ⋱ & ⋯ \\ ⋯ & ⋯ & ⋯ & ⋱ & ⋱ & ⋱ \\ ⋯ & ⋯ & ⋯ & ⋯ & ⋱ & ⋱\end{matrix} ] = \frac{{k}_{1} {θ}_{1}}{{h}_{1}} [ \begin{matrix}D & 1 & 0 & 0 & ⋯ & ⋯ \\ 1 & D & 1 & 0 & ⋯ & ⋯ \\ 0 & 1 & D & 1 & ⋯ & ⋯ \\ 0 & 0 & 1 & D & ⋱ & ⋯ \\ ⋯ & ⋯ & ⋯ & ⋱ & ⋱ & ⋱ \\ ⋯ & ⋯ & ⋯ & ⋯ & ⋱ & ⋱\end{matrix} ] \\ and & ( 34 ) \\ {\hat{K}}_{31}^{T} = {\hat{K}}_{13} = - \frac{{k}_{1} {θ}_{1}}{{h}_{1}} \{ \begin{matrix}1 \\ 0 \\ 0 \\ 0 \\ ⋮ \\ ⋮\end{matrix} \} \\ and & ( 35 ) \\ {\hat{K}}_{33} = \frac{1}{Δ t} {M}_{33} + {θ}_{1} {K}_{33} = \frac{{k}_{1} {θ}_{1}}{2 {h}_{1}} D \\ where \\ a = \frac{1}{{Δ t}_{1}} {ρ}_{1} {c}_{1} {h}_{1} + 2 {θ}_{1} \frac{{k}_{1}}{{h}_{1}} = \frac{{k}_{1} {θ}_{1}}{{h}_{1}} ( 2 + \frac{{ρ}_{1} {c}_{1} {h}_{1}^{2}}{{k}_{1} {Δ t}_{1} {θ}_{1}} ) , \\ b = - \frac{{k}_{1} {θ}_{1}}{{h}_{1}} , \\ and \\ D = 2 + \frac{{ρ}_{1} {c}_{1} {h}_{1}^{2}}{{k}_{1} {Δ t}_{1} {θ}_{1}} . & ( 36 ) \\ Let \\ {\tilde{K}}_{11} = \frac{{h}_{1}}{{k}_{1} {θ}_{1}} {\hat{K}}_{11} = [ \begin{matrix}D & 1 & 0 & 0 & ⋯ & ⋯ \\ 1 & D & 1 & 0 & ⋯ & ⋯ \\ 0 & 1 & D & 1 & ⋯ & ⋯ \\ 0 & 0 & 1 & D & ⋱ & ⋯ \\ ⋯ & ⋯ & ⋯ & ⋱ & ⋱ & ⋱ \\ ⋯ & ⋯ & ⋯ & ⋯ & ⋱ & ⋱\end{matrix} ] & ( 37 )\end{matrix}$$

The inverse of the matrix \hat{K}₁₁ can be expressed as

$${\hat{K}}_{11}^{- 1} = \frac{{h}_{1}}{{k}_{1} {θ}_{1}} {\tilde{K}}_{11}^{- 1} \qquad ( 38 )$$

Letting ξ be the upper-left value of \tilde{K}₁₁⁻¹ (the first value on the diagonal), we have

$${S}^{( 1 )} = \frac{{k}_{1} {θ}_{1}}{2 {h}_{1}} D - {( \frac{{k}_{1} {θ}_{1}}{{h}_{1}} )}^{2} ( \frac{{h}_{1}}{{k}_{1} {θ}_{1}} ξ ) = \frac{{k}_{1} {θ}_{1}}{2 {h}_{1}} D - \frac{{k}_{1} {θ}_{1}}{{h}_{1}} ξ = \frac{{k}_{1} {θ}_{1}}{{h}_{1}} ( \frac{1}{2} D - ξ ) \qquad ( 39 )$$

Based on the work of Hu and O'Connell, the value of ξ can be written as

$$ξ = \frac{sinh [ ( {N}_{node} - 1 ) λ ]}{sinh ( {N}_{node} λ )} \qquad ( 40 )$$

where N_{node} is the number of nodes in subdomain 1, and

$$λ = {cosh}^{- 1} ( \frac{D}{2} ) .$$

For large nλ,

$$sinh ( n λ ) \approx \frac{1}{2} {e}^{n λ} ,$$

and we have ξ≈e^{(-λ).}

Letting

$$\hat{χ} = \frac{{ρ}_{1} {c}_{1} {h}_{1}^{2}}{2 {k}_{1} {Δ t θ}_{1}} ,$$

we have D=2(1+\hat{X}). It can be shown with some algebra that

$$ξ = 1 + \hat{χ} - {( {\hat{χ}}^{2} + 2 \hat{χ} )}^{1 / 2} \qquad ( 41 )$$

So, we have

$${S}^{( 1 )} \approx \frac{{k}_{1} {θ}_{1}}{{h}_{1}} {( {\hat{χ}}^{2} + 2 \hat{χ} )}^{1 / 2} \qquad ( 42 )$$

Thus, the general value of α (the Robin parameter) for 1D is

$$α = {S}^{( 1 )} \approx \frac{{k}_{1}}{{h}_{1}} {( {\hat{χ}}^{2} + 2 {θ}_{1} χ )}^{1 / 2} \qquad ( 43 )$$

For the forward Euler in subdomain 1, we have θ₁=0. Letting

$$χ = {θ}_{1} \hat{χ} = \frac{{ρ}_{1} {c}_{1} {h}_{1}^{2}}{2 {k}_{1} {Δ t}_{1}} ,$$

and substituting into Eq. (42), we have

$${S}^{( 1 )} \approx \frac{{k}_{1} χ}{{h}_{1}} = \frac{{ρ}_{1} {c}_{1} {h}_{1}}{2 {Δ t}_{1}} \qquad ( 44 )$$

Through the approximation, the Schur complement matrix in 1D is approximated by a scalar value of α, which is a function of the material property, spatial discretization and timestep. As illustrated in FIG. 4,

$$α = \frac{{S}_{1} - {S}_{2}}{2}$$

(the red solid line) is the dividing line for the stability, when

$$α < \frac{{S}_{1} - {S}_{2}}{2} , \\ ‖ {e}^{p + 1} \text{/} {e}^{p} ‖ > 1$$

and the time integration of the DR coupling is unstable; while when

$$α \geq \frac{{S}_{1} - {S}_{2}}{2} , \\ ‖ {e}^{p + 1} \text{/} {e}^{p} ‖ < 1$$

and the DR coupling is stable. When α=S⁽¹⁾ (the blue dash line), ∥e^{p+1}/e^{p}∥=0 and the method converge in one iteration. Thus, the definition of a in Eq. (43) is an optimal value for convergence of the 1D problem.

This approximation process is easy to extend to multiple dimensions. For 2D and 3D problems, the Schur complement matrix is approximated by a diagonal matrix. The diagonal of the matrix is computed based on the definition of Robin parameters in Eq. (43) for each node on the shared interface. By using the novel approximation scheme, the computation of the matrix inverse in the Schur matrix is avoided and approximation of the optimal convergence is obtained. In the following section, we will use the term in Eq. (43) for the 2D problem to show the advantages of the novel approximation.

### 3. Numerical Investigation

In this section, several 2D numerical examples are carried out to investigate the performance of the novel Robin interface matching scheme for multi-time stepping modeling of the transient heat conduction problem. The algorithm is implemented in MATLAB®. The numerical examples are used to explore stability, convergence and accuracy under different time integrators. Finally, a multi-time stepping simulation is performed to compare with the line heat source model widely used in transient heat conduction for AM simulation.

### 3.1. Examination of the Effects of Robin Parameter α

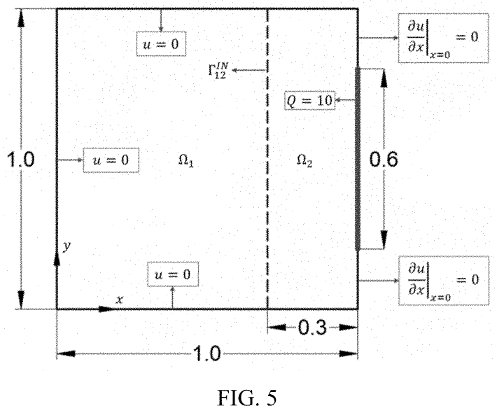

In the first numerical example, the influence of the approximated Robin parameter α on the convergence domain decomposition is investigated. FIG. 5 presents the model of a square domain, which is divided into two subdomains, Ω₁ and Ω₂. A constant temperature of u(x, y)=0 is added on the top, bottom and left sides of the domain. A heat source of Q(x, y)=10 is subjected on the middle of right-side of the domain. The length of the heat source is 0.6. A mesh of 50×50 quadrilateral elements is used to discretize the domain and solve the transient heat transfer problem. The mesh size is Δx=Δy=0.02. The material properties in the two regions are equal to each other: k₁=k₂=1.0 and ρ₁c₁=ρ₂c₂=1.0. The implicit time integration scheme is used for both subdomain 1 and subdomain 2. A Dirichlet boundary condition is applied to the interface for subdomain 1 while a Robin boundary condition is applied for subdomain 2. For comparison, a fully coupled implicit scheme is employed as the reference to examine the performance.

The timesteps for both the DR coupling scheme and reference implicit scheme are set to be Δt=0.0005. Based on the Eq. (43), the optimal Robin parameter for the given problem is

$${α}^{opt} \approx \frac{{k}_{1}}{{h}_{1}} {( {χ}^{2} + 2 χ )}^{\frac{1}{2}} = 49.99 ,$$

and the augmented matrix A₃₃=αI, where I denotes the identity matrix and the size is determined by the number of nodes on the interface Γ₁₂^{IN}. To investigate the influence of α on the stability and accuracy of the modeling, we set the value of α to [10⁻⁴, 10⁻³, 10⁻², 10⁻¹, 1,10, 10², 10³, 10⁴]×α^{opt} and compare with the fully coupled results.

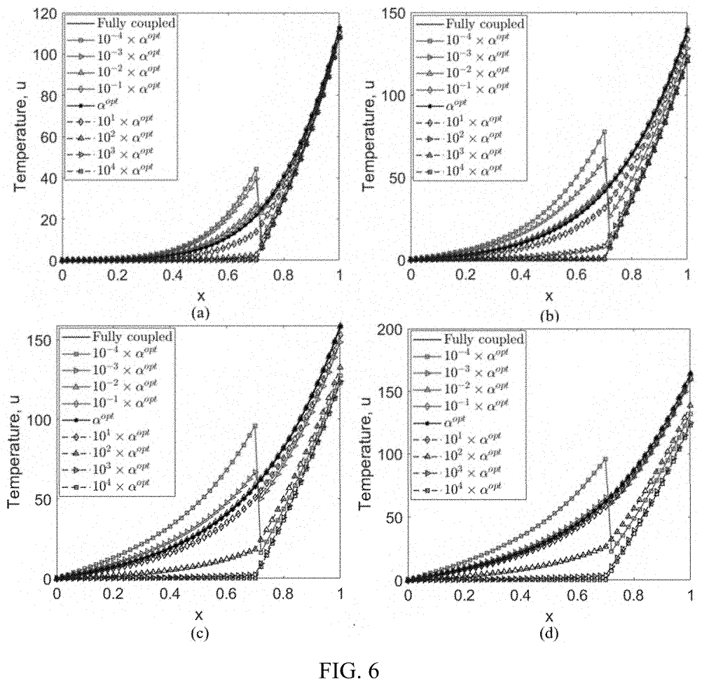

FIG. 6 shows temperature distributions of horizontal midline at the time steps t=0.05, t=0.1, t=0.2 and t=0.3 with different a values. Panel (a): Temperature at t=0.05. Panel (b): Temperature at t=0.1. Panel (c): Temperature at t=0.2. Panel (d): Temperature at t=0.3.

Table 1 tabulates the corresponding error estimations. The error is defined as

$$error = \frac{{Σ}_{i}^{{n}_{p}} \vert {u ( {x}_{i} , α )}^{DR} - {u ( {x}_{i} )}^{Implicit} \vert}{{Σ}_{i}^{{n}_{p}} \vert {u ( {x}_{i} )}^{Implicit} \vert} \qquad ( 45 )$$

where u(xᵢ, α)^{DR} denotes temperature distribution obtained by the DR scheme under different Robin parameters, u(x)^{Implicit} is the temperature distribution obtained by the reference implicit scheme. The nodal coordinates at node i are given by xᵢ, and nₚ denotes the number of nodes for error estimation.

As illustrated in Table 1, the performance of the DR coupling scheme is greatly influenced by the value of the Robin parameter. When the Robin parameter is smaller than the optimal value, severe oscillation is observed on the coupled interface between subdomain 1 and subdomain 2. The decrease of the Robin parameter leads to the increase of the error comparing with the reference implicit scheme. When the Robin parameter is larger than the optimal value, although the time integration is stable, the convergence is pretty slow. The increase of the Robin parameter results in the increase of the error and the slower of the convergence. By comparison, the DR coupling by using the optimal Robin parameter achieves the smallest error. The observation for the 2D problem is consistent with the 1D stability plot shown in FIG. 4, in which the novel analytical solution for the Robin parameter achieves good stability and convergence for the DR coupling in multi-time stepping modeling. This proves that the novel optimal Robin parameter can also be extend to 2D problem.

TABLE 1
Error estimation of the temperature distribution for implicit
DR coupling scheme under different Robin parameters
with respect to the fully coupled implicit scheme

| | t = 0.05 | t = 0.1 | t = 0.2 | t = 0.3 |
|---|---|---|---|---|
| α = 10⁻⁴ α^{opt} | 26.79% | 43.67% | 45.88% | 40.76% |
| α = 10⁻³ α^{opt} | 20.99% | 25.59% | 13.34% | 5.52% |
| α = 10⁻² α^{opt} | 6.82% | 3.65% | 1.32% | 0.49% |
| α = 10⁻¹ α^{opt} | 5.98% | 3.58% | 1.41% | 0.55% |
| α = α^{opt} | 4.01% | 1.91% | 0.61% | 0.21% |
| α = 10¹ α^{opt} | 9.22% | 11.30% | 7.87% | 4.29% |
| α = 10² α^{opt} | 22.26% | 37.83% | 41.66% | 37.09% |
| α = 10³ α^{opt} | 25.20% | 45.36% | 56.89% | 58.65% |
| α = 10⁴ α^{opt} | 25.52% | 46.24% | 58.86% | 61.72% |

### 3.2. Comparison with Dirichlet-Neumann Coupling Scheme

Conventionally, the Dirichlet-Neumann (DN) coupling scheme is employed to address the boundary interaction for the domain decomposition problem. However, the DN coupling may lead to undesirable slow convergence or divergence for certain choices of material or discretization parameters. The DR scheme is thus proposed to mitigate the convergence and stability problems of DN scheme. For demonstration purpose, the second numerical example is used to explore the stability of the novel DR scheme for heterogeneous material distribution by comparing with the DN scheme.

The model used in Section 3.1 is applied for the comparison. Again, the implicit time scheme without domain decomposition is used as a reference. The timesteps for all three cases are set to be Δt=0.0005 and the simulation is terminated when t=0.5. Three different heterogeneous thermal conductivity distributions are investigated and are tabulated in Table 2.

TABLE 2
Different schemes for the comparison between
DN coupling and DR coupling

| | Distribution 1 | Distribution 2 | Distribution 3 |
|---|---|---|---|
| k1 | 10 | 10 | 20 |
| k2 | 10 | 20 | 10 |

For Distribution 1, a uniform conductivity of 10 is set in both regions 1 and 2. The temperature distribution at two cross sections of the domain is plotted for comparison; one line is located at the middle of the domain along y direction while the other line is the interface Γ₁₂^{IN} of the two regions. FIG. 5 presents the temperature along the two cross sections at the time steps t=0.05, t=0.1 and t=0.2, respectively, while Table 2 tabulates the corresponding relative error of the two cross sections. The error is defined as

$$error = \frac{{Σ}_{i}^{{n}_{p}} \vert {u ( {x}_{i} )}^{DN \text{/} DR} - {u ( {x}_{i} )}^{Implicit} \vert}{{Σ}_{i}^{{n}_{p}} \vert {u ( {x}_{i} )}^{Implicit} \vert} \qquad ( 46 )$$

where u(xᵢ)^{DN/DR} denotes temperature distribution obtained by DN scheme or DR scheme, u(x)^{Implicit} is the temperature distribution obtained by the reference implicit scheme. It can be observed from Table 3 that the temperature obtained by DN scheme is closer to implicit scheme than the DR scheme. As the increase of the time, the error for both the DN scheme and DR scheme become smaller and smaller. For instance, the error for DN scheme decreases from 0.25% to 0.03% for horizontal midline, while for domain interface the error decreases from 0.56% to 0.02%. For the DR scheme, the same trend is observed. Moreover, both the errors obtained from DN scheme and DR scheme for the uniform conductivity problem are in an accessible region (i.e., smaller than 5%). This implies that both schemes can be used for accelerating the transient problem with uniform conductivity.

TABLE 3
Error estimation of the temperature distribution for the
DN and DR schemes with respect to the fully coupled
implicit scheme for Distribution 1

| | | t = 0.05 | t = 0.1 | t = 0.2 |
|---|---|---|---|---|
| Horizontal | DN | 0.25% | 0.12% | 0.03% |
| midline | DR | 1.01% | 0.9% | 0.45% |
| Domain | DN | 0.56% | 0.14% | 0.02% |
| interface | DR | 3.10% | 1.59% | 0.61% |

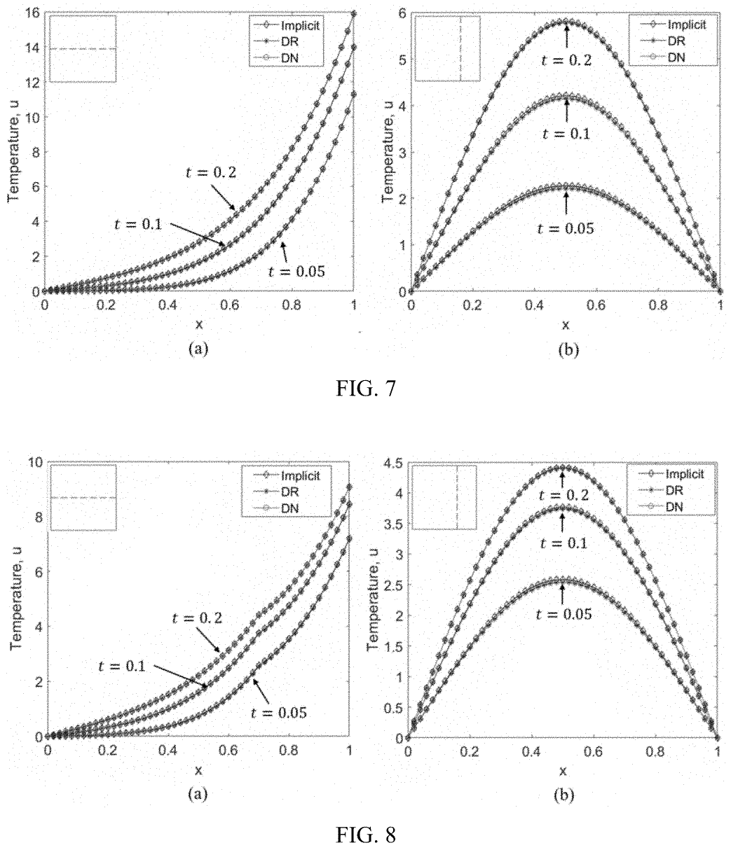

FIG. 7 shows temperature distributions of the two cross sections at the time steps t=0.05, t=0.1 and t=0.2 for the Scheme 1. Panel (a): Temperature at the horizontal midline. Panel (a): Temperature at the domain interface.

In the second distribution, the piecewise uniform conductivities in regions 1 and 2 are equal to 10 and 20, respectively. The same cross sections as the previous example at the same times are measured, as shown in FIG. 8 and Table 4. As can be seen, both the DN scheme and DR scheme shows good agreement with the fully coupled implicit scheme for Distribution 2. The similar trend for the error estimation as Distribution 1 is also observed. The errors decrease as the increase of the time.

TABLE 4
Error estimation of the temperature distribution for the
DN and DR schemes with respect to the fully coupled
implicit scheme for Distribution 2

| | | t = 0.05 | t = 0.1 | t = 0.2 |
|---|---|---|---|---|
| Horizontal | DN | 0.29% | 0.10% | 0.02% |
| midline | DR | 1.12% | 0.70% | 0.21% |
| Domain | DN | 0.42% | 0.11% | 0.02% |
| interface | DR | 1.95% | 0.89% | 0.23% |

FIG. 8 shows temperature distributions of the two cross sections at the time steps t=0.05, t=0.1 and t=0.2 for the Scheme 2. Panel (a): Temperature at the horizontal interface. Panel (b): Temperature at the domain interface.

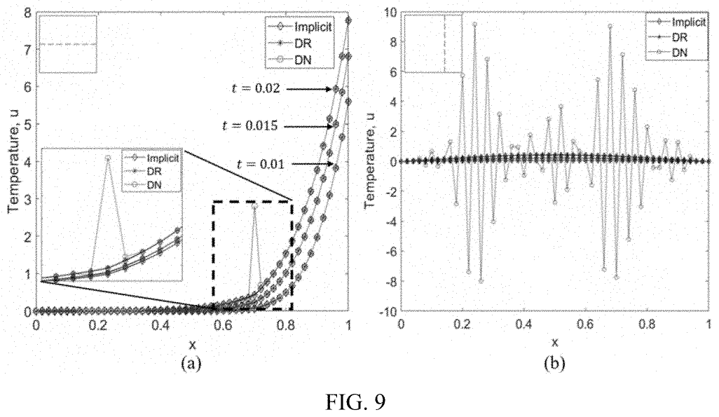

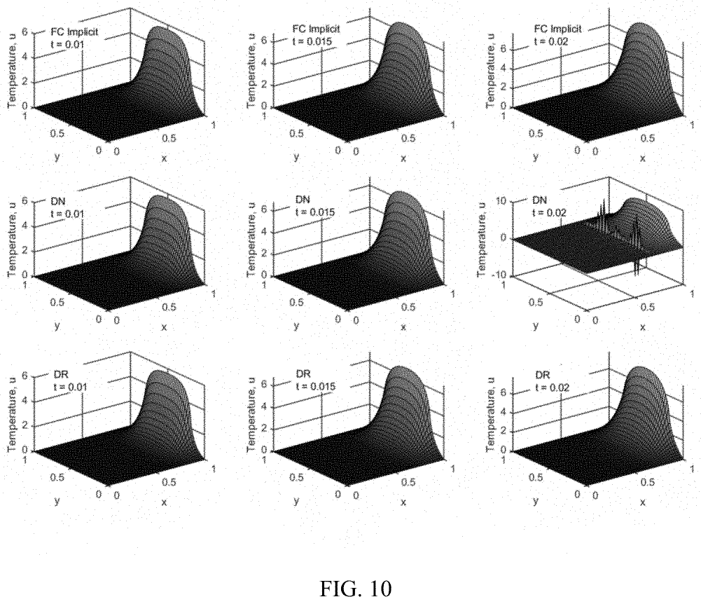

In the third distribution, we exchange the values of conductivity in the two regions employed in Distribution 2. The same cross sections are studied. In contrast to the previous two distributions, for the DN scheme the temperature at the interface begins to diverge at the time step t=0.018. So, simulation results across the cross sections are plotted at three-time steps, t=0.01, t=0.015 and t=0.02 in FIGS. 9-10. The errors are tabulated in Table 5. Obviously, strong oscillation is encountered from the DN coupling at the interface between regions 1 and 2. For instance, the error of DN scheme on domain interface increases to 970.98% after only 0.015, while the error from DR scheme decreases from 7.43% to 4.1%. This proves that the DN coupling scheme cannot be used for the problem which the conductivity at the low temperature region is larger than high temperature region. In contrast, the novel DR coupling method is able to achieve reasonably accurate results compared to the reference implicit time scheme. This demonstrates that the novel DR coupling can be efficiently and accurately used for different heterogeneous thermal conductivity distributions. Especially, for Distribution 3, the developed DR method can obtain better results while the conventional DN method diverges.

TABLE 5
Error estimation of the temperature distribution for the
DN and DR schemes with respect to the fully coupled
implicit scheme for Distribution 2

| | | t = 0.01 | t = 0.015 | t = 0.02 |
|---|---|---|---|---|
| Horizontal | DN | 0.11% | 5.22% | — |
| midline | DR | 0.11% | 0.34% | 0.53% |
| Domain | DN | 5.99% | 970.98% | — |
| interface | DR | 7.43% | 4.1% | 2.17% |

FIG. 9 shows temperature distributions of the two cross sections at the time steps t=0.01, t=0.015 and t=0.02 for the Scheme 3. Panel (a): Temperature at the horizontal interface. Panel (b): Temperature at the domain interface. FIG. 10 shows surface plots for the temperature distributions obtained by the implicit, DR and DN schemes at the time t=0.01, t=0.015 and t=0.02.

### 3.3. Accuracy and Convergence Study

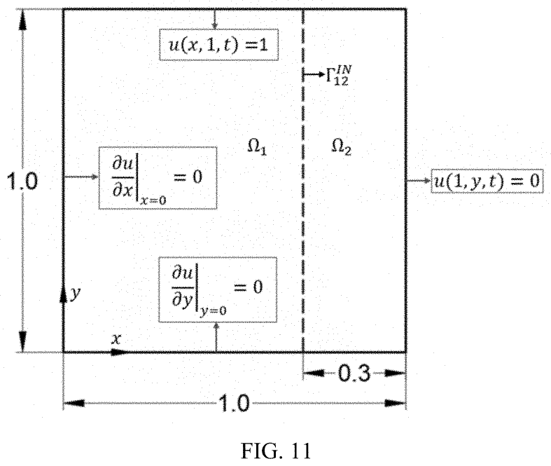

The second numerical example is used to explore the accuracy and convergence of the novel DR coupling scheme for domain decomposition. FIG. 11 illustrates the model used for the investigation. A square domain with side length l is divided into two regions along the x direction. Region 1 has a length of 0.7 along the x direction while the length in region 2 is 0.3. The interface between region 1 and region 2 is Γ₁₂^{N}. Adiabatic boundary conditions are applied to the bottom side and left-hand side of the square domain. A constant temperature of u(1, y, t)=0 is added to the right-hand side of the domain. At the top side of the domain, a constant temperature of u(x, 1, t)=1 is added. Initially, the domain is at a uniform temperature of u(x, y, 0)=1.

According to the prescribed boundary conditions and initial conditions, the transient heat conduction can be formulated as

$$\begin{matrix}\frac{\partial u}{\partial t} = \frac{{\partial }^{2} u}{\partial {x}^{2}} + \frac{{\partial }^{2} u}{\partial {y}^{2}} & ( 47 ) \\ Initial conditions \text{:} u ( x , y , 0 ) = 1 & ( 48 ) \\ Boundary conditions \text{:} \{ \begin{matrix}\frac{\partial u}{\partial x} {\vert}_{x = 0} = 0 \\ \frac{\partial u}{\partial y} {\vert}_{y = 0} = 0 \\ u ( 1 , y , t ) = 0 \\ u ( x , 1 , t ) = 1\end{matrix} & ( 49 )\end{matrix}$$

Following the derivation of Mackowski, the analytical solution uₕ for the problem in Eq. (47)-(49) is

$${u}_{h} = {\sum }_{n = 1}^{∞} {\sum }_{m = 1}^{∞} {A}_{mn} cos ( {λ}_{n} x ) cos ( {β}_{m} y ) {e}^{- ( {λ}_{n}^{2} + {β}_{m}^{2} ) t} - 2 {\sum }_{n = 1}^{∞} \frac{{( - 1 )}^{n} cos ( {λ}_{n} x ) cosh ( {λ}_{n} y )}{{λ}_{n} cosh ( {λ}_{n} )} \\ where \\ {λ}_{n} = \frac{π}{2} ( 2 n - 1 ) , n = 1 , 2 , … \\ {β}_{m} = \frac{π}{2} ( 2 m - 1 ) , = 1 , 2 , … \\ {A}_{mn} = \frac{4 {( - 1 )}^{n + m} {λ}_{n}}{{β}_{m} ( {λ}_{n}^{2} + {β}_{m}^{2} )} \qquad ( 50 )$$

To estimate the accuracy of the novel methodology, the L₂ norm is used to quantify the relative error with respect to exact solution and

$${e}_{{L}_{2}} = {( \frac{{\int }_{0}^{1} {( {u}_{FEM} - {u}_{h} )}^{2} dx}{{\int }_{0}^{1} {( {u}_{h} )}^{2} dx} )}^{1 \text{/} 2} \qquad ( 51 )$$

where e_{L}_{₂} represents the second order error norm, u_{FEM} denotes the numerical solution obtained from the DR coupling scheme while uₕ is the exact solution.

For investigation purpose, the domain is meshed by quadrilateral linear elements with elemental length of

$$Δ x = [ \frac{1}{30} , \frac{1}{60} , \frac{1}{120} , \frac{1}{200} ] ,$$

respectively. The timestep used for the exploration is set be

$$Δ {t}_{s} = Δ {t}_{{Ω}_{1}} = Δ {t}_{{Ω}_{2}} = 0.1 \times [ 1 , \frac{1}{2} , \frac{1}{4} , \frac{1}{8} , \frac{1}{16} , \frac{1}{32} , \frac{1}{64} , \frac{1}{128} , \frac{1}{256} , \frac{1}{512} ] .$$

The implicit time scheme is applied by using the DR coupling at the interface to simulate the transient problem.

The exact solution and the numerical results for this case with

$$Δ {t}_{s} = 0.1 \times \frac{1}{4} and Δ x = \frac{1}{60}$$

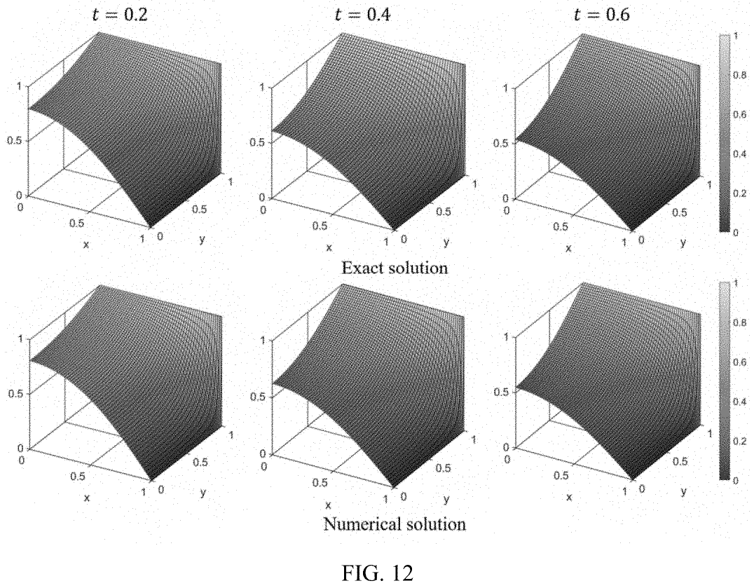

at the time steps t=0.2, t=0.4 and t=0.6 are given in FIG. 12. It is found that the novel DR coupling scheme yields accurate results compared to the exact solution. There is no observed discontinuity along the interface Γ₁₂^{N}. This implies that the DR coupling is able to achieve smooth solution along the interface.

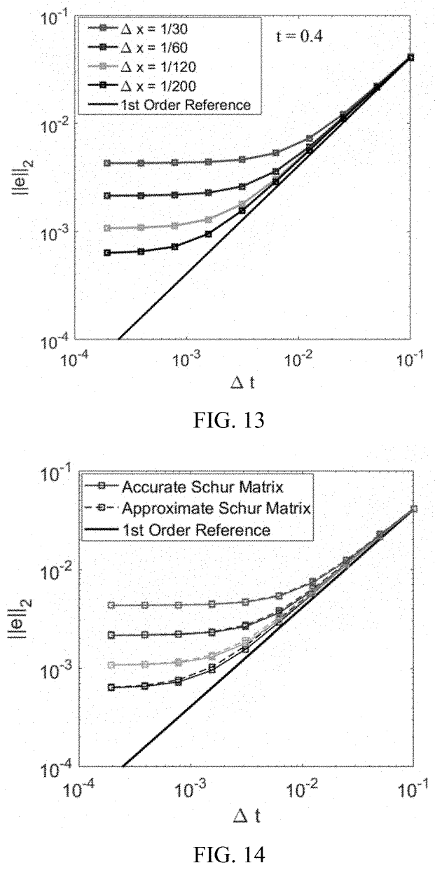

To investigate the convergence of the novel scheme, the L₂ norm error at time steps t=0.4 are plotted in FIG. 13. As illustrated in the figure, the novel DR scheme with the implicit time method can achieve first order convergence for the L₂ norm error. The fully coupled implicit scheme is the backward Euler method, which best convergence rate is first order. This proves that the developed DR method can maintain accuracy and guarantee the convergence at the same time.

We further explore the performance of the approximation term over the accurate Schur complement matrix. The comparison is given in FIG. 14. The solid lines with square markers are obtained by a fully accurate calculation of the Schur complement while the dashed line with square markers result from the novel diagonal matrix approximation. It can be observed that the approximated Schur complement matrix is in good agreement with the exact matrix computation for different spatial discretization. This demonstrates that the novel approximation process is able to achieve relatively accurate approximation for the Schur complement matrix.

### 3.4. Study of Different Time Integration Schemes

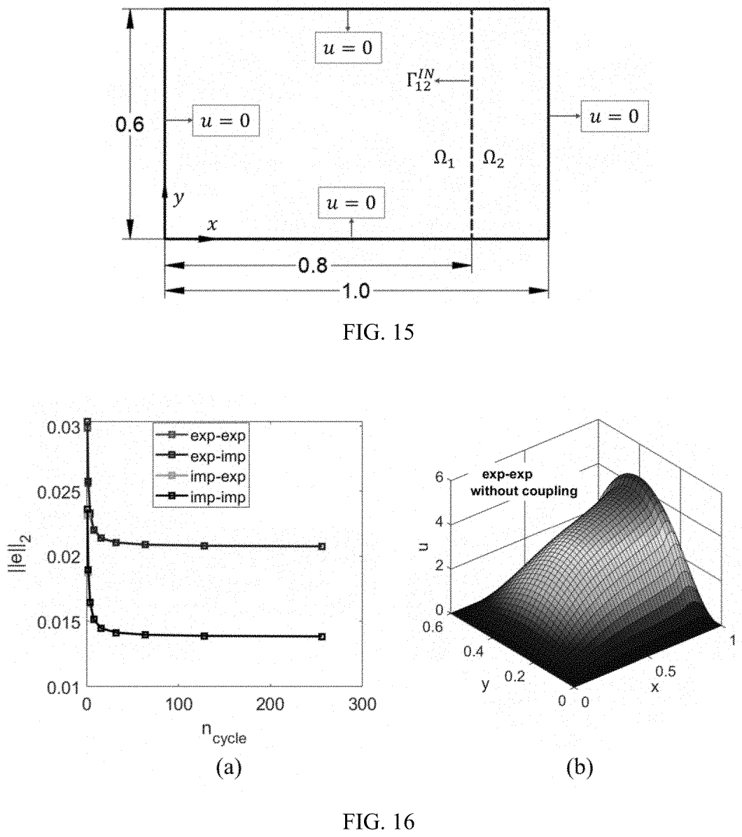

In this subsection, we study the performance of the novel DR coupling for different time-integration schemes. We note that an implicit or explicit method can be independently chosen in each of the two regions, and so we analyze four different coupling schemes: 1) explicit-explicit, 2) explicit-implicit, 3) implicit-explicit and 4) implicit-implicit schemes. The numerical model used for the investigation is illustrated in FIG. 15. A rectangular domain Ω with dimensions 1.0×0.6 is divided into two subdomains Ω₁ and Ω₂ by a vertical interface at x=0.8. A uniform temperature of u(x, y, 0)=10 is applied initially to the entire domain; afterward, homogeneous boundary conditions are applied to all four boundaries. The material properties in the two regions are constant over each individual region: k₁=1.0, ρ₁c₁=10 and k₂=0.2, ρ₂c₂=10. A mesh of 50×30 linear quadrilateral elements is used to discretize the domain and solve the transient heat transfer problem.

First, we study the influence of the timestep difference between the two regions on the accuracy under different time integrators. For this purpose, the time step at region 1 is fixed to be Δtₛ=Δt₁=1×10⁻³ , which is half value of the stable timestep for an explicit scheme, while the time step at region 2 is some fraction of this: Δt₂=Δt₁/n_{cycle} where n_{cycle} is an integer. In our numerical tests we use values of n_{cycle} given by powers of two, from 1 to 256. In the time integration scheme, therefore, the solution in region 2 is updated n_{cycle} times for every one update of region 1. For validation purposes, an explicit time integration scheme without domain decomposition will be taken as the reference for error estimation. The timestep of reference explicit scheme is equal to Δt₂=Δt₁/256.

Panel (a) of FIG. 16 presents the L₂ error of the four time integration schemes with respect to the reference explicit scheme, while panel (b) of FIG. 16 shows the temperature distribution obtained from the reference explicit scheme at time t=0.4 s. As can be seen, the error based the reference explicit scheme is decreased as the increase of the scale factor n_{cycle}. This means that the decrease of the time step at region 2 leads to better accuracy. This implies that under the same system time step length Δt_{sys}=Δt₁, large time scale results in better performance. On the other hand, it is observed that the time integration scheme at region 1 plays an important role in the error. For instance, the implicit scheme at region 1 shows relatively smaller error than the explicit scheme in region 1. In addition, the time integration at region 2 has little influence on the error, i.e., the both exp-exp and exp-imp, and imp-exp and imp-imp are at the same error level even for different scale factor.

We further study the performance of the novel DR coupling scheme for the four time integration schemes under different length of the region 1. The length is divided by a ratio of γ=[0.2, 0.3, 0.4, 0.5, 0.6, 0.7, 0.8], respectively. Other boundary conditions are the same as previous two examples. The scale factor of n_{cycle} is set to be 50 in this case, which means that Δt₁=1×10⁻³ s=50Δt₂. The simulation is terminated when the time at region 1 is equal to 1 s. The explicit time scheme with Δt₂ is used as the reference to estimate the performance of DR coupling.

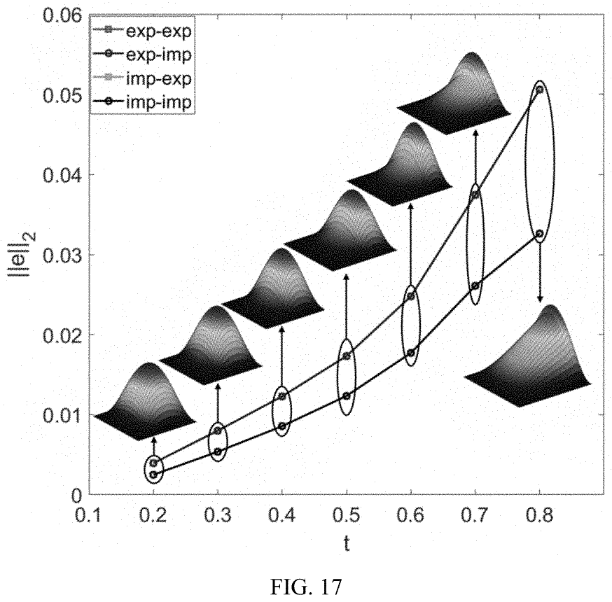

FIG. 17 presents the L₂ error of the four time integration schemes with different field ratio at t=1.0 s. It can be observed that as the field ratio increases, the L₂ error is increased. This implies that the ratio of the small-time scale region over the entire domain also influences the accuracy of the simulation compared with the reference explicit time scheme. The larger the small time-scale region, the more accurate the prediction. Again, we observe that the implicit time scheme in region 1 gives smaller error than the explicit time scheme, while the contribution of error in region 2 has negligible effect since the timestep size is much smaller.

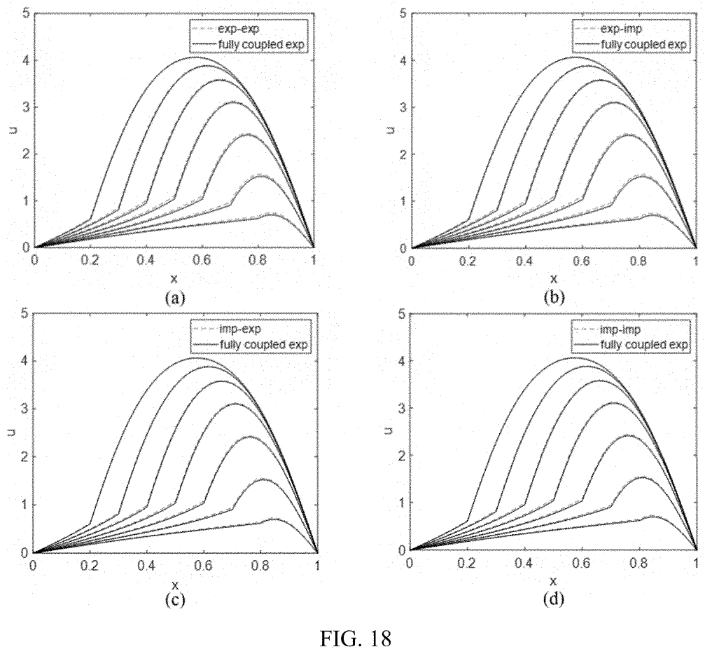

To further investigate accuracy of the novel DR coupling under different time integration schemes, we plot the temperature along the centerline of the domain at t=1.0 s with respect to different field ratios (FIG. 18). It is observed that the novel DR coupling agrees well with the prediction by the reference explicit time integration with smaller timestep. This further proves the efficiency and accuracy of the novel DR coupling for multi-time stepping problem in different field ratio.

FIG. 18 illustrates temperature distributions at the center line along y-direction for the four-time integration schemes with different field ratio γat t=1.0 s, comparing to explicit time scheme with small time step. Panel (a): Comparison between exp-exp with fully coupled exp. Panel (b): Comparison between exp-imp with fully coupled exp. Panel (c): Comparison between imp-exp with fully coupled exp. Panel (d): Comparison between imp-imp with fully coupled exp.

### 3.5. Application for Metal AM

One important motivation for the development of the DR coupling-based multi-time stepping method is to address the inefficiencies encountered in the simulation of problems such as AM. To show the advantage of the novel scheme, a simplified two-dimensional model for AM simulation is solved using the novel DR coupling for multi-time stepping simulation. The model geometry is shown in FIG. 19. A rectangular domain of 3.5 mm×0.8 mm has a constant temperature of u=0 applied on the four boundaries. A Gaussian heat source model is initially centered near the left side of the domain:

$${Q}_{in} ( x , y , t ) = \frac{2 q}{π {R}_{0}^{2}} exp ( - \frac{2}{{R}_{0}^{2}} ( {( x - {x}_{0} ( t ) )}^{2} + {( y - {y}_{0} ( t ) )}^{2} ) ) \qquad ( 52 )$$

where Qᵢₙ is the input heat flux at position (x, y) and time t, q is the laser powder, R₀ denotes the radius of the Gaussian heat source model, and x₀(t) and y₀(t) are the coordinates of the heat source center at time t.

The domain is discretized into a regular mesh of 350×80 quadrilateral elements. The material properties for the simulation, which are assumed constant in time for simplicity, are tabulated in Table 6. The laser is initially centered at position (x₀, y₀)=[0.4, 0.4] mm and moved in the positive x-direction with velocity vₓ=0.5 m/s.

TABLE 6
General properties for Case 4

| General properties | Values | |
|---|---|---|
| Density (ρ) | 4500 | kg/m³ |
| Conductivity (k) | 12 | W/m · K |
| Heat capacity (Cₚ) | 700 | J/kg · K |
| Laser power (q) | 400 | kW |
| Laser radius (R₀) | 5 · 10⁻⁵ | m |
| Total time (tₜₒₜₐₗ) | 0.52 | s |
| Laser initial position (X₀, Y₀) | [0.4, 0.4] | mm |
| Scan speed (vₓ, v_{y}) | [0.5, 0] | m/s |
| Mesh size Δx | 0.01 | mm |
| Maximum time step for explicit | 6.5625 × 10⁻⁶ | s |
| $time scheme Δ {t}_{0} = \frac{Δ {x}^{2}}{2 k ρ {C}_{p}}$ | | |

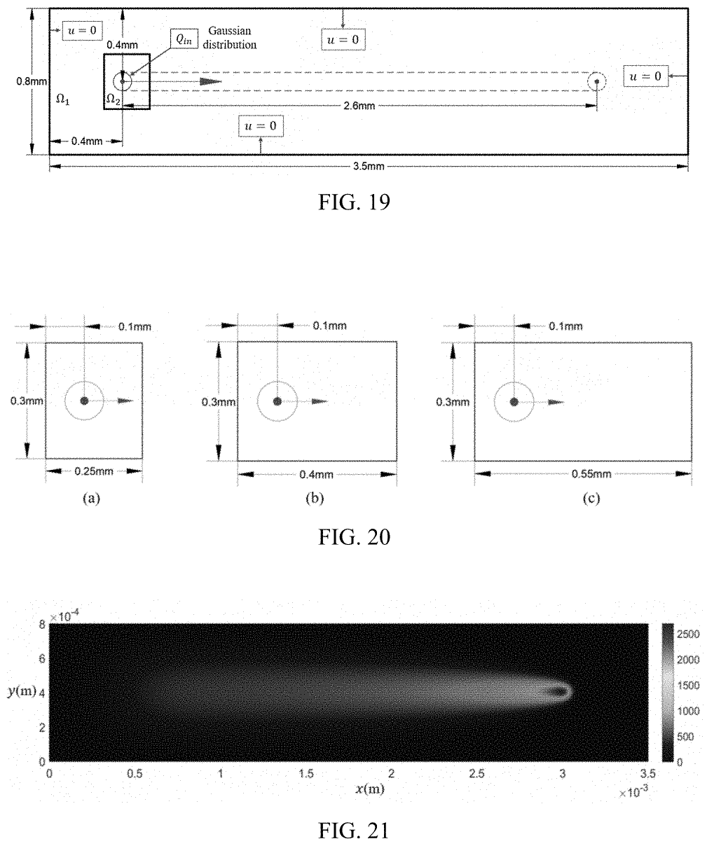

To accelerate the simulation, the domain is divided into two regions (subdomains), region 1 and region 2 (see FIG. 19). In region 1, an implicit time integration scheme is employed for the update of the temperature, while for region 2 an explicit scheme is used. Two timesteps are defined for the two regions, Δt₁ for region 1 and Δt₂=Δt₀ (the maximum explicit time step) for region 2. The position of region 2 is moved at intervals of Δt₁. In each movement, we ensure that the heat source center is placed at the same relative position, as shown in FIG. 20. Three different timestep differences between region 1 and region 2 are studied in this case: Δt₁=20t₂, Δt₁=50Δt₂, and Δt₁=100Δt₂. To avoid the heat source moving outside region 2 over time Δt₁, the size of region 2 in the x-direction is different for the three cases: 0.25 mm, 0.4 mm, and 0.55 mm, respectively. FIG. 20 shows dimension of region 2 for the three-time schemes. Panel (a): Δt₁=20Δt₂. Panel (b): Δt₁=50Δt₂. Panel (c): Δt₁=100Δt₂.

For comparison, the implicit time scheme without domain decomposition is solved with time steps Δt₁=Δt₀, 20Δt₀, 50Δt₀, and 100Δt₀. In this implicit model, the heat source model for large time step (i.e., Δt₁=20Δt₀, 50Δt₀, 100Δt₀) is determined by using the line heat source model. The development of line heat source model aims to accelerate the simulation of powder bed process by averaging the heat source over scanning path, and allows large time increments.

To validate the accuracy of the simulations, a fully coupled simulation with implicit time integration and the timestep is Δt₁=Δt₀ is performed as the reference to compare the novel DR coupling with the line heat source model. The temperature obtained by the reference simulation at time t=0.52 s is given in FIG. 21. As can be seen, a high temperature tail is generated after the heat source is moved from left to right. The maximum temperature is Tₘₐₓ=2690° C.

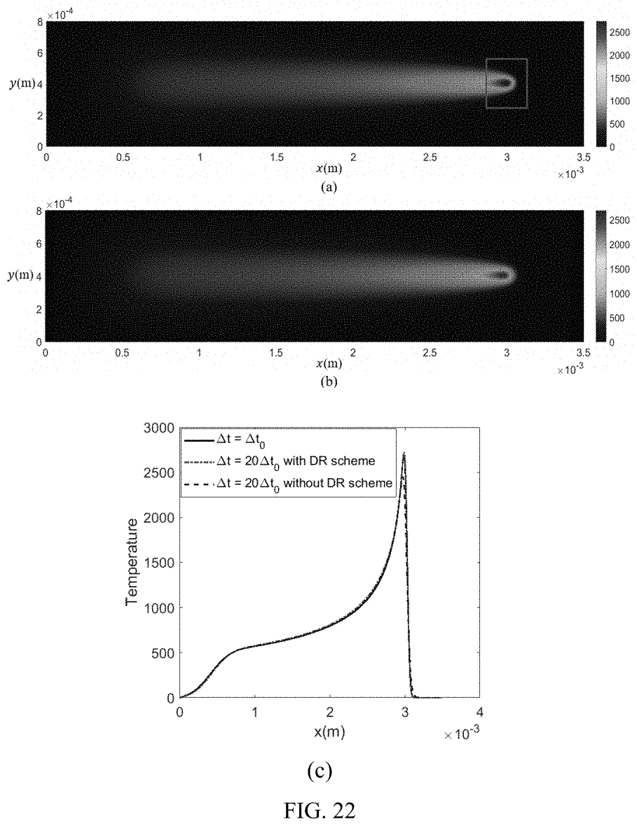

We first conducted the simulation on the case of Δt₁=20Δt₂=20Δt₀ for both implicit-explicit with DR coupling, and the line heat source model case with implicit scheme. The temperature distributions for the two simulations are presented in panels (a)-(b) of FIG. 22, while the temperature of the centerline in the y-direction is plotted in panel (c) of FIG. 22. The red box in panel (a) of FIG. 22 represents region 2 in the DR-coupling with an explicit scheme, which contains the heat source center. It can be observed that the temperature distribution obtained from the novel DR coupling is in a good agreement with the reference implicit scheme with a smaller timestep. Both the peak temperature (i.e., Tₘₐₓ^{DR}=2725° C., 1.3% difference) and distribution agree well with the prediction compared with the reference simulation. For the temperature distribution obtained with the line heat source model, the agreement is good over much of the solution, but the peak temperature (i.e., Tₘₐₓ^{no_DR}=2451° C., 8.9% difference) in the melting pool region does not match as well as the novel DR coupling method. The error for the prediction of maximum temperature with line heat source model is about 6.8 times larger than the novel methodology. This demonstrates that the novel multi-time stepping is able to more accurately represent the melt pool temperature compared with the fully coupled scheme with a large timestep.

FIG. 22 shows temperature distributions at time t=0.52 by using both implicit-explicit DR coupling and the implicit without DR coupling for Δt₁=20Δt₀. Panel (a): Temperature distribution obtained by implicit-explicit DR coupling. Panel (b): Temperature distribution obtained by line heat source model. Panel (c): Temperature at the centerline of y-direction.

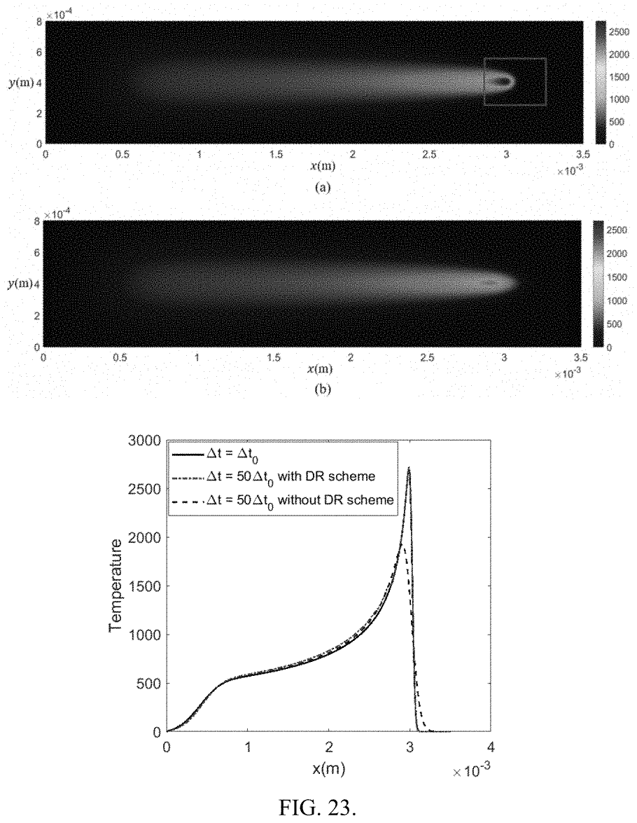

The simulation results for Δt₁=50Δt₀ are presented in FIG. 23 including the temperature distributions for the DR-coupled and fully coupled cases, and the temperature distribution at the centerline of y-axis. It can be seen that as the time step in region 1 increases, the temperature distribution obtained by the novel method is still in good agreement with the reference simulation. The maximum temperature is the same as the previous Δt₁=20Δt₀ example (Tₘₐₓ^{DR}=2725° C.). However, for the fully-coupled implicit scheme with Δt=20Δt₀ and the line heat source, the melt pool region temperature is obviously not as accurate as the novel multi-time scale scheme, as shown in panel (c) of FIG. 23. For example, the maximum temperature is 1925° C., 28.99% lower than the reference simulation.

FIG. 23 shows temperature distributions at time t=0.52 by using both implicit-explicit DR coupling and the implicit without DR coupling for Δt₁=50Δt₀. Panel (a): Temperature distribution obtained by implicit-explicit DR coupling. Panel (b): Temperature distribution obtained by line heat source model. Panel (c): Temperature at the centerline of y-direction.

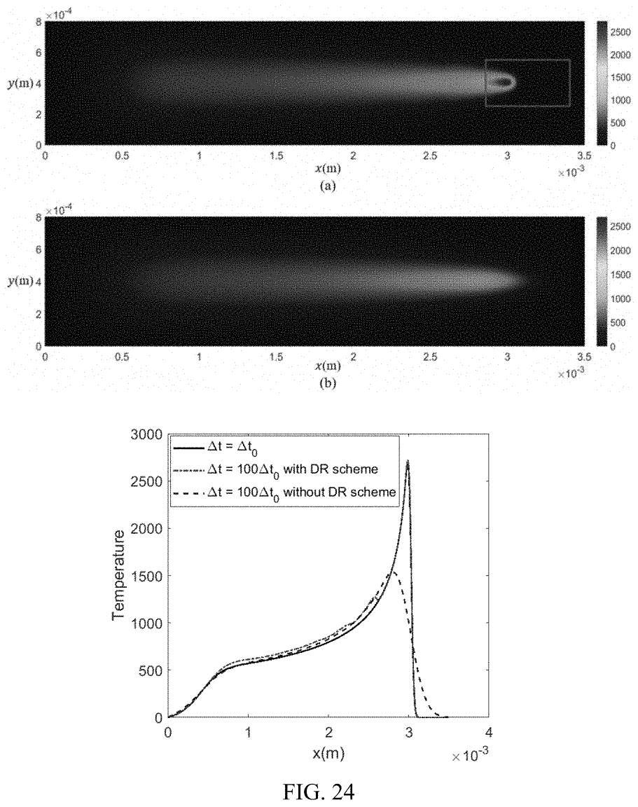

Similarly, results with Δt₁=100Δt₀ are given in FIG. 24, which shows temperature distributions at time t=0.52 by using both implicit-explicit DR coupling and the implicit without DR coupling for Δt₁=100Δt₀. Panel (a): Temperature distribution obtained by implicit-explicit DR coupling. Panel (b): Temperature distribution obtained by line heat source model. Panel (c): Temperature at the centerline of y-direction. The novel method maintains the accuracy of the temperature distribution as the previous two different timestep combinations. In particular, in the heat source region, the novel methodology is again in very good agreement with the reference simulation (i.e., Tₘₐₓ^{DR}=2724° C. and 1.26% difference). However, for the implicit method with line heat source model, the maximum temperature is far smaller than the value from the reference simulation, i.e., 1532° C. and 43.05% lower. This further demonstrates the accuracy of the novel methodology, especially near the melt pool.

On the other hand, since the region 2 updated by explicit time scheme is only a very small region comparing to the region 1 (i.e., 2.68% for Δt₁=20Δt₀, 4.29% for Δt₁=50Δt₀ and 5.89% for Δt₁=100Δt₀), the computational cost is much lower than the implicit scheme. This additionally illustrates the efficiency and potential acceleration of the novel methodology for the AM simulation.

In the exemplary example, for simplicity, material properties are assumed to be independent of the temperature in the AM simulation. The method can be systematically extended to transient heat conduct problems with temperature-dependent material properties with effectiveness for AM simulation.

### 4. Conclusion

In this exemplary work, a multi-time stepping algorithm based on a Dirichlet-Robin iteration method is developed in order to accelerate simulation of transient heat conduction problems. According to the multi-time stepping algorithm, the conventional Dirichlet-Neumann iteration is replaced with the Dirichlet-Robin iteration in the enforcement of the continuity for both the primary variable and its ratio on the interfaces of subdomains. This avoids the instability encountered in the Dirichlet-Neumann iteration method for heterogenous material properties, mesh sizes, or timesteps on opposite sides of the interface. The slow convergence due to the small value of introduced artificial relaxation parameters is also circumvented. Further, the method according to the embodiments of the invention is unconditionally stable and there is no dependence on the relative properties of the media along the interface. Particularly, in contrast with the previous Dirichlet-Robin iteration method, an accurate augmentation matrix is derived based on the approximation of the Schur complement matrix. This significantly reduces the problem of artificial selection of the Robin augmentation matrix or the potential cost for computation of the Schur complement matrix. Thus, both the accuracy and efficiency of the Dirichlet-Robin iteration method are guaranteed.

Several numerical examples are used to investigate and demonstrate the performance of the novel methodology. First, we investigate the influence of the magnitude of the Robin parameters. It has been demonstrated that the novel analytical formulation is close to the optimal approximation. For instance, the increase or decrease of the Robin parameter leads to worse results comparing with fully coupled scheme. Second, by comparing with the Dirichlet-Neumann iteration method, it is proved that the disclosed novel method is unconditional stable for heterogenous material distribution on the both sides of the interface. Third, a convergence test of the novel method is performed. Very good agreement is observed between use of an exact evaluation of the Schur complement matrix and the novel approximation. We also systematically explore the performance of the method for different mixed time integrators (i.e., explicit-explicit, explicit-implicit, implicit-explicit, implicit-implicit). The novel method is demonstrated to be robust to the choice of time integration scheme. Finally, the novel method is employed to simulate a single track in a 2D model of metal additive manufacturing. Compared with a fully coupled method using a line heat source model, it is found that the novel method can not only accelerate the simulation process, but also achieve high accuracy in the high-temperature region.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1] L. Cheng, P. Zhang, E. Biyikli, J. X. Bai, J. Robbins, and A. To, “Efficient design optimization of variable-density cellular structures for additive manufacturing: theory and experimental validation,” (in English), Rapid Prototyping Journal, vol. 23, no. 4, pp. 660-677, 2017, doi: 10.1108/Rpj-04-2016-0069.

[2] L. Cheng et al., “Natural Frequency Optimization of Variable-Density Additive Manufactured Lattice Structure: Theory and Experimental Validation,” Journal of Manufacturing Science and Engineering, vol. 140, no. 10, p. 105002, 2018.

[3] M. Shiomi, K. Osakada, K. Nakamura, T. Yamashita, and F. Abe, “Residual stress within metallic model made by selective laser melting process,” CIRP Annals-Manufacturing Technology, vol. 53, no. 1, pp. 195-198, 2004.

[4] P. Mercelis and J.-P. Kruth, “Residual stresses in selective laser sintering and selective laser melting,” Rapid Prototyping Journal, vol. 12, no. 5, pp. 254-265, 2006.

[5] B. Ahmad, S. O. van der Veen, M. E. Fitzpatrick, and H. Guo, “Residual stress evaluation in selective-laser-melting additively manufactured titanium (Ti-6Al-4V) and inconel 718 using the contour method and numerical simulation,” Additive Manufacturing, vol. 22, pp. 571-582, 2018/Aug. 1, 2018, doi: https://doi.org/10.1016/j.addma.2018.06.002.

[6] L. Cheng, X. Liang, J. Bai, Q. Chen, J. Lemon, and A. To, “On utilizing topology optimization to design support structure to prevent residual stress induced build failure in laser powder bed metal additive manufacturing,” Additive Manufacturing, vol. 27, pp. 290-304, 2019.

[7] T. Craeghs, S. Clijsters, J. P. Kruth, F. Bechmann, and M. C. Ebert, “Detection of Process Failures in Layerwise Laser Melting with Optical Process Monitoring,” Physics Procedia, vol. 39, pp. 753-759, 2012/Jan. 1, 2012, doi: https://doi.org/10.1016/j.phpro.2012.10.097.

[8] Q. Yang, P. Zhang, L. Cheng, Z. Min, M. Chyu, and A. C. To, “Finite element modeling and validation of thermomechanical behavior of Ti-6Al-4V in directed energy deposition additive manufacturing,” Additive Manufacturing, vol. 12, pp. 169-177, 2016.

[9] M. Mazur, M. Leary, S. Sun, M. Vcelka, D. Shidid, and M. Brandt, “Deformation and failure behaviour of Ti-6Al-4V lattice structures manufactured by selective laser melting (SLM),” The International Journal of Advanced Manufacturing Technology, vol. 84, no. 5-8, pp. 1391-1411, 2016.

[10] H. D. Carlton, A. Haboub, G. F. Gallegos, D. Y. Parkinson, and A. A. MacDowell, “Damage evolution and failure mechanisms in additively manufactured stainless steel,” Materials Science and Engineering: A, vol. 651, pp. 406-414, 2016.

[11] M. Dryja, Additive Schwarz methods for elliptic finite element problems in three dimensions. Citeseer, 1991.

[12] M. Dryja and O. B. Widlund, “Domain decomposition algorithms with small overlap,” SIAM Journal on Scientific Computing, vol. 15, no. 3, pp. 604-620, 1994.

[13] V. Dolean, P. Jolivet, and F. Nataf, An introduction to domain decomposition methods: algorithms, theory, and parallel implementation. SIAM, 2015.

[14] T. Belytschko, H.-J. Yen, and R. Mullen, “Mixed methods for time integration,” Computer Methods in Applied Mechanics and Engineering, vol. 17, pp. 259-275, 1979.

[15] T. Belytschko and R. Mullen, “Stability of explicit-implicit mesh partitions in time integration,” International Journal for Numerical Methods in Engineering, vol. 12, no. 10, pp. 1575-1586, 1978.

[16] T. Hughes, “Implicit-explicit finite elements in transient analysis: implementation and numerical examples,” Journal of Applied mechanics, vol. 45, no. 2, pp. 375-378, 1978.

[17] T. J. Hughes, K. S. Pister, and R. L. Taylor, “Implicit-explicit finite elements in nonlinear transient analysis,” Computer Methods in Applied Mechanics and Engineering, vol. 17, pp. 159-182, 1979.

[18] P. Smolinski, “A variable multi-step method for transient heat conduction,” Computer Methods in Applied Mechanics and Engineering, vol. 86, no. 1, pp. 61-71, 1991/Mar. 1, 1991, doi: https://doi.org/10.1016/0045-7825(91)90138-V.

[19] P. Smolinski and Y.-S. Wu, “Stability of explicit subcycling time integration with linear interpolation for first-order finite element semidiscretizations,” Computer Methods in Applied Mechanics and Engineering, vol. 151, no. 3, pp. 311-324, 1998/Jan. 20, 1998, doi: https://doi.org/10.1016/S0045-7825(97)00154-0.

[20] P. Smolinski and T. Palmer, “Procedures for multi-time step integration of element-free Galerkin methods for diffusion problems,” Computers & Structures, vol. 77, no. 2, pp. 171-183, 2000/Jun. 15, 2000, doi: https://doi.org/10.1016/S0045-7949(99)00210-2.

[21] P. Smolinski, “Stability of variable explicit time integration for unsteady diffusion problems,” Computer Methods in Applied Mechanics and Engineering, vol. 93, no. 2, pp. 247-252, 1991/Dec. 1, 1991, doi: https://doi.org/10.1016/0045-7825(91)90153-W.

[22] W. Daniel, “Subcycling first- and second-order generalizations of the trapezoidal rule,” International journal for numerical methods in engineering, vol. 42, no. 6, pp. 1091-1119, 1998.

[23] P.-L. Lions, “On the Schwarz alternating method. I,” in First international symposium on domain decomposition methods for partial differential equations, 1988, vol. 1: Paris, France, p. 42.

[24] P.-L. Lions, “On the Schwarz alternating method. III: a variant for nonoverlapping subdomains,” in Third international symposium on domain decomposition methods for partial differential equations, 1990, vol. 6: SIAM Philadelphia, Pa., pp. 202-223.

[25] C. Farhat and F. X. Roux, “A method of finite element tearing and interconnecting and its parallel solution algorithm,” International Journal for Numerical Methods in Engineering, vol. 32, no. 6, pp. 1205-1227, 1991.

[26] C. Farhat, L. Crivelli, and F. X. Roux, “A transient FETI methodology for large-scale parallel implicit computations in structural mechanics,” International Journal for Numerical Methods in Engineering, vol. 37, no. 11, pp. 1945-1975, 1994.

[27] C. Farhat, P. S. Chen, and J. Mandel, “A scalable Lagrange multiplier based domain decomposition method for time-dependent problems,” International Journal for Numerical Methods in Engineering, vol. 38, no. 22, pp. 3831-3853, 1995.

[28] A. Gravouil and A. Combescure, “Multi-time-step explicit-implicit method for non-linear structural dynamics,” International Journal for Numerical Methods in Engineering, vol. 50, no. 1, pp. 199-225, 2001.

[29] A. Combescure and A. Gravouil, “A numerical scheme to couple subdomains with different time-steps for predominantly linear transient analysis,” Computer Methods in Applied Mechanics and Engineering, vol. 191, no. 11, pp. 1129-1157, 2002/Jan. 4, 2002, doi: https://doi.org/10.1016/S0045-7825(01)00190-6.

[30] A. Prakash and K. Hjelmstad, “A FETI-based multi-time-step coupling method for Newmark schemes in structural dynamics,” International Journal for Numerical Methods in Engineering, vol. 61, no. 13, pp. 2183-2204, 2004.

[31] K. Nakshatrala, K. Hjelmstad, and D. A. Tortorelli, “A FETI-based domain decomposition technique for time-dependent first-order systems based on a DAE approach,” International Journal for Numerical Methods in Engineering, vol. 75, no. 12, pp. 1385-1415, 2008.

[32] P. B. Nakshatrala, K. Nakshatrala, and D. A. Tortorelli, “A time-staggered partitioned coupling algorithm for transient heat conduction,” International Journal for Numerical Methods in Engineering, vol. 78, no. 12, pp. 1387-1406, 2009.

[33] J. Nitsche, “Über ein Variationsprinzip zur Lösung von Dirichlet-Problemen bei Verwendung von Teilräumen, die keinen Randbedingungen unterworfen sind,” in Abhandlungen aus dem mathematischen Seminar der Universität Hamburg, 1971, vol. 36, no. 1: Springer, pp. 9-15.

[34] F.-X. Roux and J.-D. Garaud, “Domain decomposition methodology with Robin interface matching conditions for solving strongly coupled fluid-structure problems,” International Journal for Multiscale Computational Engineering, vol. 7, no. 1, 2009.

[35] F.-X. Roux, “Domain Decomposition Methodology with Robin Interface Matching Conditions for Solving Strongly Coupled Problems,” in International Conference on Computational Science, 2008: Springer, pp. 311-320.

[36] T. J. Hughes, The finite element method: linear static and dynamic finite element analysis. Courier Corporation, 2012.

[37] G. Hu and R. F. O'Connell, “Analytical inversion of symmetric tridiagonal matrices,” Journal of Physics A: Mathematical and General, vol. 29, no. 7, p. 1511, 1996.

[38] K. B. Nakshatrala, A. Prakash, and K. D. Hjelmstad, “On dual Schur domain decomposition method for linear first-order transient problems,” Journal of Computational Physics, vol. 228, no. 21, pp. 7957-7985, 2009/Nov. 20, 2009, doi: https://doi.org/10.1016/j.jcp.2009.07.016.

[39] D. Soldner and J. Mergheim, “Thermal modelling of selective beam melting processes using heterogeneous time step sizes,” Computers & Mathematics with Applications, 2018/May 26, 2018, doi: https://doi.org/10.1016/j.camwa.2018.04.036.

[40] D. W. Mackowski, “Conduction heat transfer: Notes for MECH 7210.”

[41] B. Favoretto, C. De Hillerin, O. Bettinotti, V. Oancea, and A. Barbarulo, “Reduced order modeling via PGD for highly transient thermal evolutions in additive manufacturing,” Computer Methods in Applied Mechanics and Engineering, 2019.

[42] J. Goldak, A. Chakravarti, and M. Bibby, “A new finite element model for welding heat sources,” Metallurgical Transactions B, journal article vol. 15, no. 2, pp. 299-305, Jun. 1, 1984, doi: 10.1007/bf02667333.

[43] J. Irwin and P. Michaleris, “A line heat input model for additive manufacturing,” Journal of Manufacturing Science and Engineering, vol. 138, no. 11, p. 111004, 2016.

What is claimed is:

1. A method for accelerating simulation of transient heat conduction, comprising:
dividing a domain Ω of transient heat transfer bounded by a boundary of Γ into a set of subdomains {Ωᵢ}, wherein a share boundary of two neighbor subdomains Ωᵢ and Ωⱼ defines an interface Γᵢⱼ^{In} between the two neighbor subdomains Ωᵢ and Ωⱼ;
obtaining a Dirichlet-Robin (DR) coupling on the interface Γᵢⱼ^{In} as
$${k}_{i} \frac{\partial {u}_{i}}{\partial {n}_{i}} + {α}_{ij} {u}_{i} = - {k}_{j} \frac{\partial {u}_{j}}{\partial {n}_{j}} + {α}_{ij} {u}_{j} , on {Γ}_{ij}^{In} \qquad ( C1 )$$
wherein αᵢⱼ is a coefficient to guarantee continuity of the Robin boundary, uᵢ is a temperature field at the subdomains Ωᵢ, nᵢ is a unit normal vector at the Neumann boundary of the subdomains Ωᵢ, and kᵢ is thermal conductivity of a material at the subdomains Ωᵢ;
obtaining a governing equation of the transient heat conduction in the domain Ω by using the DR coupling as
$${Σ}_{i} {\int }_{{Ω}_{i}} {v}_{i} ρ {c}_{p} {\dot{u}}_{i} d Ω + {Σ}_{i} {\int }_{Ω} ∇ {v}_{i} \cdot {k}_{i} ∇ {u}_{i} d Ω + {Σ}_{i} {Σ}_{j} {\int }_{{Γ}_{ij}^{In}} {v}_{i} ( {u}_{i} - {u}_{j} ) {α}_{ij} d Γ + {Σ}_{i} {Σ}_{j} {\int }_{{Γ}_{ij}^{In}} {v}_{i} ( {k}_{i} \frac{\partial {u}_{i}}{\partial {n}_{i}} + {k}_{j} \frac{\partial {u}_{j}}{\partial {n}_{j}} ) d Γ = {Σ}_{i} {\int }_{{Ω}_{i}} {v}_{i} {Q}_{i} d Ω - {\int }_{{Γ}_{N}} {vq}_{{Γ}_{N}} d Γ \qquad ( C2 )$$
where a superposed dot denotes a time derivative, ∇ is a gradient operator, ρ is a density of the material, cₚ represents a specific heat, and q_{Γ}_{_{N}} denotes a heat flux subjected to the Neumann boundary;
formulating, without loss of generality for two or more subdomains, based on a time integration form of the temperature filed, discretization of the governing equation Eq. (C2) for the two or more subdomains in a form of
$$[ \begin{matrix}{\hat{K}}_{11} & 0 & {\hat{K}}_{13} \\ 0 & {\hat{K}}_{22} & {\hat{K}}_{23} \\ {\hat{K}}_{31} & {\hat{K}}_{32} & {\hat{K}}_{33}^{( 1 )} + {\hat{K}}_{33}^{( 2 )}\end{matrix} ] \{ \begin{matrix}{u}_{1}^{n + 1} \\ {u}_{2}^{n + 1} \\ {u}_{3}^{n + 1}\end{matrix} \} = \{ \begin{matrix}{b}_{1} \\ {b}_{2} \\ {b}_{3}^{( 1 )} + {b}_{3}^{( 2 )} + {g}_{3}^{( 1 )} + {g}_{3}^{( 2 )}\end{matrix} \} \\ wherein \\ {\hat{K}}_{ij} = \frac{1}{Δ t} {M}_{ij} + {θ}_{i} {K}_{ij} , i , j = 1 , 2 , \\ {\hat{K}}_{3 j} = {θ}_{j} {K}_{3 j} , j = 1 , 2 , \\ {\hat{K}}_{33}^{( i )} = \frac{1}{Δ t} {M}_{33}^{( i )} + {θ}_{i} {K}_{33}^{( i )} , \\ {b}_{i} = {f}_{i} + \frac{1}{Δ t} {M}_{ii} {u}_{i}^{n} - ( 1 - {θ}_{i} ) {K}_{ii} {u}_{i}^{n} - ( 1 - {θ}_{i} ) {K}_{i 3} {u}_{3}^{n} , i = 1 , 2 , \\ {b}_{3}^{( i )} = {f}_{3}^{( i )} + \frac{1}{Δ t} {M}_{33} {u}_{3}^{n} - ( 1 - {θ}_{i} ) {K}_{3 i} {u}_{i}^{n} - ( 1 - {θ}_{i} ) {K}_{33}^{( i )} {u}_{3}^{n} , i = 1 , 2 , \qquad ( C3 )$$
wherein the superscript (i) denotes a matrix or vector of the interface on the side of the subdomain Ωᵢ. Mᵢᵢ (i=1, 2) represents a positive definite capacity matrix of the subdomain Ωᵢ, Kᵢᵢ(i=1,2) is a semi-definite conductivity matrix of subdomain Ωᵢ, Kᵢ₃, K₃ᵢ and K₃₃⁽ⁱ⁾ (i=1,2) are local conductivity matrixes of the interface, M₃₃ represents a combined capacity matrix at the interface of the two subdomains and M₃₃=M₃₃⁽¹⁾+M₃₃⁽²⁾, g₃⁽¹⁾ and g₃⁽²⁾ are a discretized flux of the Robin boundary condition assigned on the interface of Γ₁₂^{IN} with g₃⁽¹⁾=−g₃⁽²⁾, f₃ represents an added volumetric heat source on the interior elements along the interface of Γ₁₂^{IN} and f₃=f₃⁽¹⁾+f₃⁽²⁾, and f₃⁽¹⁾ and f₃⁽²⁾ are volumetric heat source on the interface of Γ₁₂^{IN} from the sides of subdomains Ω₁ and Ω₂, respectively, and wherein subscripts 1 and 2 represent an arbitrary pair of neighboring subdomains, and subscript 3 denotes nodes on the interface itself;
applying, for the DR coupling, the Dirichlet boundary condition on interface Γ₁₂^{IN} for subdomain Ω₁, and adding the Robin boundary condition on the interface Γ₁₂^{IN} for subdomain Ω₂, to split the discretization in Eq. (C3) into
$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \} \qquad ( C4 )$$
for subdomain Ω₁, and
$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \} \qquad ( C5 )$$
for subdomain Ω₂, wherein \tilde{g}₃⁽²⁾ denotes an augmented flux on the interface Γ₁₂^{IN}, A₃₃⁽²⁾ is an augmentation matrix for the Robin boundary condition based on the governing equation in Eq. (C2), and is determined by the Robin coefficient αᵢⱼ in Eq. (C1); and
applying a Dirichlet-Robin iteration method to solve the discretization equations of Eqs. (C4) and (C5) for the multi-time step until the solution is converged, wherein the multi-time step comprises a system timestep Δtₛ, one subdomain is updated with the system timestep Δt₁=Δtₛ while another subdomain is updated with the timestep Δt₂=Δtₛ/nₚ, and wherein the system time updates after all the time integrations in the subdomains are completed.

2. The method of claim 1, wherein the boundary Γ comprises two complementary boundaries Γ=Γ_{D}∪Γ_{N} and Γ_{D}∩Γ_{N}=ø, wherein Γ_{D} donates the Dirichlet boundary condition that is a temperature boundary condition, and Γ_{N} donates the Neumann boundary condition that is a heat flux boundary condition.

3. The method of claim 1, wherein the time integration form of the temperature filed in one subdomain satisfies the relationship of
$${u}_{i}^{n + θ} = ( 1 - {θ}_{i} ) {u}_{i}^{n} + {θ}_{i} {u}_{i}^{n + 1}$$
wherein the superscript n represents an iteration number of time step while subscript i denotes the variable belongs to subdomain Ωᵢ, (i=1, 2), θᵢ is a coefficient used to evaluate influences of different time schemes on the current value and 0≤θᵢ≤1, uᵢ^{n+θ} represents the temperature obtained by a mixed time scheme, uᵢⁿ is the temperature value at the n-th time step, and uᵢⁿ⁺¹ denotes the temperature value at the (n+1)-th time step.

4. The method of claim 3, wherein when θᵢ=0, the time integrators are a forward Euler, while when θᵢ=1, the time integrators are a backward Euler.

5. The method of claim 1, wherein the Dirichlet-Robin iteration method comprises:
(a) for a given temperature distribution u₃^{(1),n} at the interface Γ₁₂^{IN}, solving the discretization function of Eq. (C5) in subdomain Ω₁ with the Dirichlet boundary condition u_{Γ}_{₁₂}_{^{In}}=u₃^{(1),n} on the interface Γ₁₂^{IN}, so as to obtain the temperature in subdomain Ω₁, u₁ⁿ=\hat{K}₁₁⁻¹(b₁−\hat{K}₁₃u₃^{(1),n});
(b) computing the flux on the interface Γ₁₂^{IN} using g₃⁽¹⁾=S⁽¹⁾u₃^{(1),n}−C₃⁽¹⁾, wherein S⁽¹⁾=\hat{K}₃₃⁽¹⁾−\hat{K}₃₁\hat{K}₁₁⁻¹\hat{K}₁₃ is the Schur complement matrix and includes both the mass and timestep terms, and C₃⁽¹⁾=b₃⁽¹⁾−\hat{K}₃₁\hat{K}₁₁⁻¹b₁ is a source term for grouping the influence of an external heat source;
(c) obtaining, based on the flux g₃⁽¹⁾ and Eq. (C6), the augmented flux \tilde{g}₃⁽²⁾ on subdomain Ω₂ by g₃⁽²⁾=−g₃⁽¹⁾,
$${\tilde{g}}_{3}^{( 2 )} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1} \qquad ( C6 )$$
wherein A₃₃⁽²⁾u₃^{(2),n+1} is the augmented term for imposing the Robin boundary condition on the interface Γ₁₂^{IN}, and the magnitude of the augmented flux remains constant during the subcycling of the timestep Δt₂, and solving the following discretized equation for each p until pΔt₂=Δtₛ:
$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + 1 , p + 1}\end{matrix} \} = \{ \begin{matrix} & {b}_{2} \\ {b}_{3}^{( 2 )} - & {g}_{3}^{( 1 )} + {A}_{33}^{( 2 )} {u}_{3}^{( 2 ) , n + 1 , p}\end{matrix} \} \qquad ( C7 )$$
so as to obtain the temperature in subdomain Ω₂, wherein vectors u₂^{n+1,p+1} and u₃^{(2),n+1,p+1} represent the temperature in subdomain Ω₂ and the temperature on the interface Γ₁₂^{IN} at p^{th} subtimestep of n^{th} system timestep, respectively; and
(d) once the subcycling in subdomain Ω₂ is finished, setting the temperature of the interface Γ₁₂^{IN} on the side of subdomain Ω₁ to be u₃^{(1),n+1}=u₃^{(2),n+1}, and returning to step (a) and continuing the iteration for both the system timestep and the subdomain timestep until the temperature solution is converged.

6. The method of claim 5, wherein the augmented Robin term is a function of time step, relative material properties and spatial mesh size, and is close to an optimal value.

7. The method of claim 5, further comprising:
obtaining an optimal approximation for the Schur complement matrix by analyzing a one-dimensional (1D) heat transfer problem; and
extending the optimal approximation to multiple dimensions including two-dimensional (2D) or three-dimensional (3D) heat transfer problems.

8. The method of claim 7, wherein the step of obtaining the optimal approximation comprises:
approximating A₃₃ with a scalar value of a for the 1D problem; and
approximating the Schur complement matrix S⁽¹⁾ in the 1D problem by the scalar value of α, which is a function of the material property, spatial discretization and timestep, wherein the scalar value of α (the Robin parameter) for the 1D problem is
$$α = {S}^{( 1 )} \approx \frac{{k}_{1}}{{h}_{1}} {( {χ}^{2} + 2 {θ}_{1} χ )}^{1 / 2} , wherein \\ χ = {θ}_{1} \hat{χ} = \frac{{ρ}_{1} {c}_{1} {h}_{1}^{2}}{2 {k}_{1} Δ {t}_{1}} . \qquad ( C8 )$$

9. The method of claim 7, wherein the step of extending the optimal approximation comprises:
approximating the Schur complement matrix by a diagonal matrix for 2D or 3D problems, wherein the diagonal values of the diagonal matrix are computed based on the definition of the Robin parameter in Eq. (C8) for each node on the shared interface.

10. The method of claim 5, wherein when A₃₃=S⁽¹⁾, the timestep iteration converges in one iteration.

11. The method of claim 1, being applicable for additive manufacturing (AM).

12. The method of claim 1, being capable of capturing a large temperature gradient around a melting pool region with one-hundred times acceleration.

13. A non-transitory tangible computer-readable medium storing instructions which, when executed by one or more processors, cause a system to perform the method of claim 1.

14. A system for accelerating simulation of transient heat conduction, comprising:
one or more processors configured to operably perform the method of claim 1.

15. A method for accelerating simulation of transient heat conduction, comprising:
decomposing a solution domain into a set of subdomains, wherein a share boundary of two neighbor subdomains defines an interface therebetween;
coupling the two neighbor subdomains at the interface with a Dirichlet-Robin (DR) coupling that comprises a Robin parameter used to guarantee the continuity of the Robin boundary;
obtaining governing equations of the transient heat conduction for each subdomain with the DR coupling by applying the Dirichlet boundary condition on one side of interface for one of two neighbor subdomains and adding the Robin boundary condition on the other side of the interface for the other of two neighbor subdomains, wherein the governing equations comprises a Schur complement matrix that includes both the mass and timestep terms, and an augmented matrix that is determined by the Robin parameter;
obtaining an approximation of the augmented matrix, and assigning the approximated augmented matrix to the Schur complement matrix; and
applying a Dirichlet-Robin iteration method to solve the governing equations for the multi-time step until the solution is converged.

16. The method of claim 15, wherein when the augmented matrix is equal to the Schur complement matrix, the timestep iteration converges in one iteration.

17. The method of claim 15, wherein the DR coupling on the interface satisfies
$${k}_{i} \frac{\partial {u}_{i}}{\partial {n}_{i}} + {α}_{i j} {u}_{i} = - {k}_{j} \frac{\partial {u}_{j}}{\partial {n}_{j}} + {α}_{i j} {u}_{j} , on {Γ}_{i j}^{In}$$
wherein αᵢⱼ is the Robin parameter, uᵢ is a temperature field at the subdomains Ωᵢ, nᵢ is a unit normal vector at the Neumann boundary of the subdomains Ωᵢ, and kᵢ is thermal conductivity of a material at the subdomains Ωᵢ.

18. The method of claim 17, wherein the governing equations of the transient heat conduction for each subdomain comprise
$$[ \begin{matrix}{\hat{K}}_{11} & {\hat{K}}_{13} \\ {\hat{K}}_{31} & {\hat{K}}_{33}^{( 1 )}\end{matrix} ] \{ \begin{matrix}{u}_{1}^{n + 1} \\ {u}_{3}^{( 1 ) , n + 1}\end{matrix} \} = \{ \begin{matrix}{b}_{1} \\ {b}_{3}^{( 1 )} + {g}_{3}^{( 1 )}\end{matrix} \} \qquad ( 1 )$$
for subdomain Ω₁, and
$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1} \\ {u}_{3}^{( 2 ) , n + 1}\end{matrix} \} = \{ \begin{matrix}{b}_{2} \\ {b}_{3}^{( 2 )} + {\tilde{g}}_{3}^{( 2 )}\end{matrix} \}$$
for subdomain Ω₂, wherein \tilde{g}₃⁽²⁾ denotes an augmented flux on the interface, A₃₃⁽²⁾ is the augmentation matrix.

19. The method of claim 18, wherein the augmented Robin term A₃₃⁽²⁾u₃^{(2),n+1} is a function of time step, relative material properties and spatial mesh size, and is close to an optimal value.

20. The method of claim 18, wherein the step of obtaining the approximation of the augmented matrix comprises:
approximating the augmented matrix with a scalar for a 1D case; and
extending it to a 2D/3D case by a diagonal matrix.

21. The method of claim 20, wherein the approximated Schur complement matrix S⁽¹⁾ in the 1D problem is the scalar value of α,
$$α = {S}^{( 1 )} \approx \frac{{k}_{1}}{{h}_{1}} {( {χ}^{2} + 2 {θ}_{1} χ )}^{1 / 2} , wherein$$
$$χ = {θ}_{1} \hat{χ} = \frac{{ρ}_{1} {c}_{1} {h}_{1}^{2}}{2 {k}_{1} Δ {t}_{1}} .$$

22. The method of claim 21, wherein the step of extending the approximation to a 2D/3D case comprises:
approximating the Schur complement matrix by a diagonal matrix for 2D or 3D problems, wherein the diagonal values of the diagonal matrix are computed based on the definition of the Robin parameter in Eq. (C8) for each node on the shared interface.

23. The method of claim 22, wherein the Dirichlet-Robin iteration method comprises:
(a) for a given temperature distribution u₃^{(1),n} at the interface Γ₁₂^{IN}, solving the discretization function of Eq. (C5) in subdomain Ω₁ with the Dirichlet boundary condition u_{Γ}_{₁₂}_{^{In}}=u₃^{(1),n} on the interface Γ₁₂^{IN}, so as to obtain the temperature in subdomain Ω₁, u₁ⁿ=\hat{K}₁₁⁻¹(b₁−\hat{K}₁₃u₃^{(1),n});
(b) computing the flux on the interface Γ₁₂^{IN} using g₃⁽¹⁾=S⁽¹⁾u₃^{(1),n}−C₃⁽¹⁾, wherein S⁽¹⁾=\hat{K}₃₃⁽¹⁾−\hat{K}₃₁\hat{K}₁₁⁻¹\hat{K}₁₃ is the Schur complement matrix and includes both the mass and timestep terms, and C₃⁽¹⁾=b₃⁽¹⁾−\hat{K}₃₁\hat{K}₁₁⁻¹b₁ is a source term for grouping the influence of an external heat source;
(c) obtaining, based on the flux g₃⁽¹⁾ and Eq. (C6), the augmented flux \tilde{g}₃⁽²⁾ on subdomain Ω₂ by g₃⁽²⁾=−g₃⁽¹⁾,
$${\tilde{g}}_{3}^{( 2 )} = {g}_{3}^{( 2 )} + {A}_{33}^{( 2 )} {u}_{3}^{( 2 ) , n + 1} = - {g}_{3}^{( 1 )} + {A}_{33}^{( 2 )} {u}_{3}^{( 2 ) , n + 1}$$
wherein A₃₃⁽²⁾u₃^{(2),n+1} is the augmented term for imposing the Robin boundary condition on the interface Γ₁₂^{IN}, and the magnitude of the modified flux remains constant during the subcycling of the timestep Δt₂, and solving the following discretized equation for each p until pΔt₂=Δtₛ:
$$[ \begin{matrix}{\hat{K}}_{22} & {\hat{K}}_{23} \\ {\hat{K}}_{32} & {\hat{K}}_{33}^{( 2 )} + {A}_{33}^{( 2 )}\end{matrix} ] \{ \begin{matrix}{u}_{2}^{n + 1 , p + 1} \\ {u}_{3}^{( 2 ) , n + 1 , p + 1}\end{matrix} \} = \{ \begin{matrix}{b}_{2} \\ {b}_{3}^{( 2 )} - {g}_{3}^{( 1 )} + {A}_{33}^{( 2 )} {u}_{3}^{( 2 ) , n + 1 , p}\end{matrix} \}$$
so as to obtain the temperature in subdomain Ω₂, wherein vectors u₂^{n+1,p+1} and u₃^{(2),n+1,p+1} represent the temperature in subdomain Ω₂ and the temperature on the interface Γ₁₂^{IN} at p^{th} subtimestep of n^{th} system timestep, respectively; and
(d) once the subcycling in subdomain Ω₂ is finished, setting the temperature of the interface Γ₁₂^{IN} on the side of subdomain Ω₁ to be u₃^{(1),n+1}=u₃^{(2),n+1}, and returning to step (a) and continuing the iteration for both the system timestep and the subdomain timestep until the temperature solution is converged.

24. A non-transitory tangible computer-readable medium storing instructions which, when executed by one or more processors, cause a system to perform the method of claim 15.

25. A system for accelerating simulation of transient heat conduction, comprising:
one or more processors configured to operably perform the method of claim 15.
